(19) United States
(12) Patent Application Publication
(10) Pub. No.: US 2016/0370835 A1
(43) Pub. Date: Dec. 22, 2016

(54) POWER-OVER-ETHERNET TO UNIVERSAL SERIAL BUS CHARGING PORT CONTROLLER

(71) Applicant: Leviton Manufacturing Co., Inc., Melville, NY (US)

(72) Inventors: Jason Erickson, Bothell, WA (US); William J. Lauby, Mukilteo, WA (US); Ryan Moore, Seattle, WA (US); Dean S. Lipke, Mill Creek, WA (US)

(21) Appl. No.: 15/183,760

(22) Filed: Jun. 15, 2016

Related U.S. Application Data
(60) Provisional application No. 62/180,997, filed on Jun. 17, 2015.

(51) Int. Cl. G06F 1/26; G06F 1/32; G06F 13/38; H02J 7/00; G06F 13/42

(52) U.S. Cl. CPC G06F 1/266; H02J 7/0052; H02J 7/0045; G06F 13/4282; G06F 13/385; G06F 1/3287; H02J 2007/0059; H02J 2007/0062

(57) ABSTRACT

A power conversion device is configured to convert power-over-Ethernet (PoE) power to universal serial bus (USB) power to yield a USB charging port. The conversion device can conform to a number of modular and/or portable form factors, allowing existing Ethernet data ports to be easily converted to USB charging ports. The conversion device receives PoE power from the Ethernet network, converts the PoE power to an appropriate USB standard, and delivers the power to an integrated USB charging port. The conversion device can identify the charging capabilities of a portable device plugged into the USB charging port and set a maximum charging current based on the rated charging current of the portable device. In some embodiments, the conversion device can be incorporated in an apparatus that also facilitates data transfer via the USB port.

### CROSS-REFERENCE TO RELATED APPLICATIONS

This application claims priority to U.S. Provisional Patent Application Ser. No. 62/180,997, filed on Jun. 17, 2015, and entitled “POWER-OVER-ETHERNET TO UNIVERSAL SERIAL BUS CHARGING PORT CONTROLLER,” the entirety of which is incorporated by reference.

### TECHNICAL FIELD

The disclosed subject matter relates generally to universal serial bus (USB) charging ports, and, for example, to modular or portable devices that convert power-over-Ethernet (PoE) to universal serial bus (USB) power for charging of electronic devices, and that negotiate a maximum charging current with the electronic device being charged.

### BACKGROUND

Prior to the emergence of wireless networks, users wishing to access the Internet from a public location—e.g., a library, an airport, a hospital waiting room, a classroom, etc.—or from their home, were required to locate and connect to a physical data port, typically an RJ45 Ethernet port. The growth of wireless networking (e.g., WiFi) has significantly reduced the need for such physical data ports in residential and public buildings.

Because of the rapid evolution from hard-wired to wireless networking, a large number of unused or abandoned physical Ethernet ports remain installed in many residential and public buildings that had been wired for physical networking before wireless networks became ubiquitous.

In parallel with the growth of wireless networking, personal electronic devices such as mobile phones, tablet computers and the like have evolved to include USB ports for data connectivity and device charging. As a result of these developments, the need for physical Ethernet data ports has declined, while the need for readily available USB charging stations has increased.

The above-described deficiencies of current data and charging port architectures are merely intended to provide an overview of some of the problems of current technology, and are not intended to be exhaustive. Other problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments relate to portable and/or modular devices for converting existing data ports to USB charging ports. In one or more embodiments, a modular conversion device converts PoE power to USB power for charging of a portable device. The conversion device can comprise, for example, a modular jack configured to be installed in a wall plate as a replacement for an existing PoE-enabled data port (e.g., an RJ45 port), where the PoE-enabled data port is connected to a PoE source such as a PoE injector, a PoE midspan, a PoE switch, or other form of power injection that adheres to PoE standards. The modular device can convert available PoE power on the PoE-enabled data port to USB power for delivery via a USB charging port included on the module.

In another example embodiment, the conversion device can comprise a portable conversion device (e.g., a dongle) configured to plug into an existing PoE-enabled data port. The portable device converts available PoE power from the data port to USB power for delivery via a USB charging port on the device.

In one or more embodiments, the conversion device can include a charging controller that negotiates a maximum allowable current draw with the USB device plugged into the conversion device's USB charging port. When a USB device is plugged into the USB charging port, the charging controller can identify a device class (or charging class) to which the device belongs, where the device class indicates the rated charging current for the device. Based on the determined device class, the charging controller can configure the maximum allowable current output of the conversion device (e.g., by configuring an output circuit that sets the maximum allowable current draw), thereby allowing different classes of USB devices to charge their batteries at or near their rated charging currents.

Some embodiments may comprise multi-port conversion devices that include both a USB charging port and an RJ45 data port. According to such embodiments, the conversion device plugs into or replaces an existing PoE-enabled RJ45 data port, converts available PoE power to USB power for delivery via a USB charging port on the device, and also extends data connectivity from the existing RJ45 data port to a native data port of the conversion device.

In some embodiments, the conversion device's USB charging port can also support data communications (e.g., communication via TCP/IP protocol). Such embodiments can format USB data received at the USB port to conform to an Ethernet protocol (e.g., TCP/IP) and send the formatted data over an Ethernet network. Likewise, the conversion device can format Ethernet data received from the network to conform to USB protocol for delivery to the USB port of the conversion device.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

FIG. 1 is a diagram of an example power conversion device.

FIG. 2 is a diagram of a power conversion device that includes a charging control component capable of setting a maximum charging output based on a determination of the charging capabilities of the USB device being charged.

FIGS. 3A and 3B are diagrams illustrating the exchange of a device signature and a port type signature between a portable USB device and a power conversion device.

FIG. 4 is a diagram illustrating configuration of a conversion component of a power conversion device based on a detected device signature of a portable USB device.

FIG. 5 is a diagram of an example dual-port power conversion device.

FIG. 6A illustrates a wall plate with six Ethernet data ports.

FIG. 6B illustrates a wall plate with three PoE-enabled Ethernet data ports replaced with modular USB charging ports.

FIG. 7 illustrates a PoE-to-USB power conversion device connected to a PoE switch via an Ethernet cable.

FIG. 8 is a side view of a power conversion unit installed in wall plate.

FIG. 9 illustrates a portable USB charging port device configured to plug into an existing PoE-enabled Ethernet port.

FIG. 10 illustrates a portable USB charging port configured to plug into an RJ45 jack.

FIG. 11 illustrates a USB charging port attached to an RJ45 plug via a USB cable.

FIG. 12 illustrates a conversion device that both converts PoE power to USB power and facilitates transfer of data between a USB device and an Ethernet network.

FIG. 13 illustrates a wall-mounted USB-to-TCP/IP conversion device.

FIG. 14 is a diagram illustrating the use of USB-to-TCP/IP conversion devices to establish a remote USB port.

FIG. 15 illustrates a two-port embodiment of a modular PoE-to-USB power conversion device.

FIG. 16 illustrates a multimedia interface embodiment for providing charging and audio/video data connectivity over an HDBaseT link.

FIG. 17 is a diagram illustrating a virtual reality receiver module suitable for establishing remote connections between source devices and virtual reality devices.

FIG. 18 is a diagram illustrating the use of virtual reality receiver modules to establish a remote connection between a virtual reality client device and a source device.

FIG. 19 illustrates a modular wireless networking device configured to leverage PoE power.

FIG. 20 is a flowchart of an example methodology for converting PoE power to USB power.

FIG. 21 is an example computing environment.

FIG. 22 is an example networking environment.

### DETAILED DESCRIPTION

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As used in the subject specification and drawings, the terms “object,” “module,” “interface,” “component,” “system,” “platform,” “engine,” “selector,” “manager,” “unit,” “store,” “network,” “generator” and the like are intended to refer to a computer-related entity or an entity related to, or that is part of, an operational machine or apparatus with a specific functionality; such entities can be either hardware, a combination of hardware and firmware, firmware, a combination of hardware and software, software, or software in execution. In addition, entities identified through the foregoing terms are herein generically referred to as “functional elements.” As an example, a component can be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer-readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As an example, a component can be an apparatus with specific functionality provided by mechanical parts operated by electric or electronic circuitry, which is operated by software, or firmware application executed by a processor, wherein the processor can be internal or external to the apparatus and executes at least a part of the software or firmware application. As another example, a component can be an apparatus that provides specific functionality through electronic components without mechanical parts, the electronic components can include a processor therein to execute software or firmware that confers at least in part the functionality of the electronic components. Interface(s) can include input/output (I/O) components as well as associated processor(s), application(s), or API (Application Program Interface) component(s). While examples presented hereinabove are directed to a component, the exemplified features or aspects also apply to object, module, interface, system, platform, engine, selector, manager, unit, store, network, and the like.

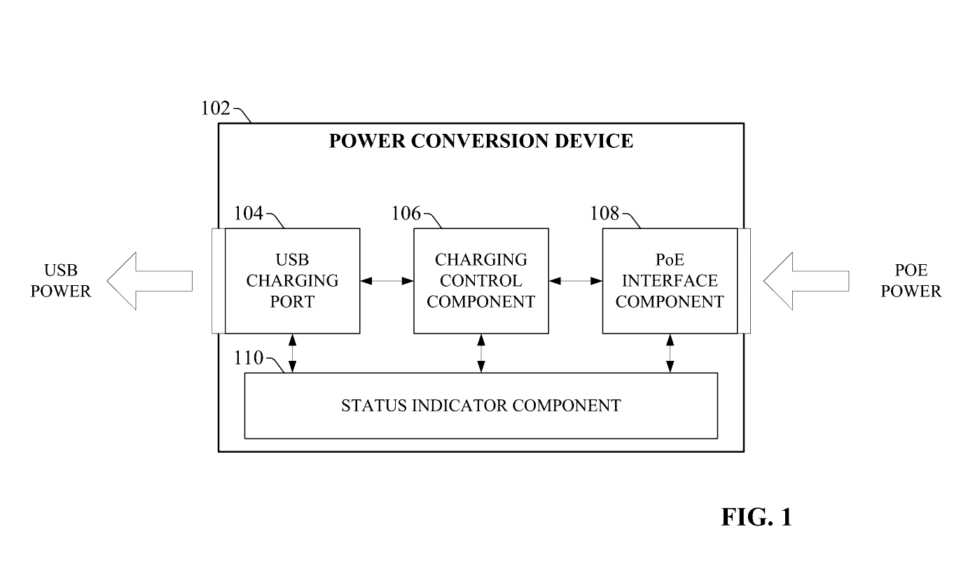

FIG. 1 illustrates an example power conversion device 102 capable of converting a data port (e.g., an RJ45 Ethernet port) to a USB charging port. Power conversion device 102 receives power-over-Ethernet (PoE) power via a PoE interface component 108. In one or more embodiments, PoE interface component 108 can receive power from a PoE switch, which delivers power over Ethernet cable (e.g., CAT-5 cable), or from any suitable source of PoE power. Any suitable method can be used to interface the PoE interface component 108 with the PoE power source. In a non-limiting example, PoE interface component 108 can include wiring terminals that can be electrically connected to an output port of the PoE power source (e.g., by terminating conductors of an Ethernet cable on the terminals of the PoE interface component 108). In another example embodiment, the PoE interface component 108 can include an RJ45 plug that inserts into an existing RJ45 Ethernet port, allowing PoE power available on the Ethernet port to be delivered to the PoE interface component 108. These various designs are described in more detail below.

Power conversion device 102 also includes a charging control component 106 configured to electrically convert the PoE power received at the PoE interface component 108 to USB-compatible power. Given the multiple standards in use for transmission of PoE power (e.g., IEEE 802.3af, 802.3at, etc.), one or more embodiments of charging control component 106 can automatically detect which standard is being used to transmit the PoE power detected by PoE interface component 108. For example, IEEE 802.3af delivers 12.95 watts (W) of power at a nominal voltage of 48 VDC (typically between 37 and 57 VDC) and a maximum current of 350 milliamps (mA), while IEEE 802.3at delivers 25.5 W power at a voltage range of 42.5-57.0 VDC and maximum current of 600 mA. In response to detection of input power received by PoE interface component 108 (e.g., from a PoE switch), charging control component 106 can determine whether the PoE power conforms to IEEE 802.3af or 802.3at. Depending on the determined PoE standard, charging control component 106 will convert the received PoE power to USB power. It is to be appreciated that embodiments of the power conversion device 102 are not limited to those that convert PoE power conforming to either IEEE 802.3af or 802.3at, and that various embodiments of the power conversion device 102 can be configured to convert PoE power conforming to any standard.

As will be described in more detail below, the charging control component 106 can set the rated output for the converted USB power based on the charging class of the device plugged into the USB charging port 104. For example, charging power for some USB 2.0 devices can be delivered at 5 VDC with a maximum current of 500 mA, while charging power for some USB 3.0 devices can be delivered at 5 VDC with a maximum current of 900 mA. Some USB devices may also be configured to charge at voltage levels higher than 5 VDC. Accordingly, the charging control component 106 can be configured to detect when such devices are plugged into the USB charging port 104 and deliver charging power at the appropriate voltage level in accordance with the device's charging capabilities.

Charging control component 106 can identify the PoE standard based on one or more of the detected voltage level, a detected power level, a detected current, or a determination of which conductors of the Ethernet cable are delivering the PoE power. Since PoE power can be delivered on different conductors of the Ethernet cable depending on the standard being used, charging control component 106 can be configured to automatically select the appropriate power conductors of the Ethernet cable from which to draw power based on the determination of the PoE standard being used. Charging control component 106 can then convert the power delivered by the selected conductors to an appropriate USB power standard determined based on the device class of the USB device plugged into the USB charging port 104.

Charging control component 106 delivers the converted PoE power—now conforming to USB standard—to USB charging port 104, which can deliver the converted USB power to a USB-capable electronic device (e.g., phone, tablet computer, laptop, etc.). Charging control component 106 delivers the USB power—converted from the incoming PoE power—to the appropriate conductors of the USB charging port 104 to facilitate charging a connected device, thereby providing a USB charging port for the device. USB charging port 104 can conform to any USB jack type, including but not limited to standard USB, mini USB (USB type mini A, USB type mini B, etc.), micro USB (USB micro A, USB micro B, etc.), USB 2.0, USB 3.0, USB Type A, USB Type B, USB Type C, or other standard. In one or more embodiments, power conversion device 102 can include multiple USB charging ports 104, each corresponding to a different physical USB standard (e.g., standard, mini, micro, etc.) to facilitate compatibility with multiple different types of USB devices, or alternatively multiple ports of the same type.

One or more embodiments of power conversion device 102 can also include a status indicator component 110 for controlling one or more status indicators (not shown) integrated with the conversion device. The status indicators can convey status information relating to operation of power conversion device 102 including, but not limited to, an indication that PoE power is present at the PoE interface component 108, identification of the type of PoE power detected (e.g., 802.3af, 802.3at Mode 1, 802.3at Mode 2, etc.), a charging status of a connected USB device (e.g., “connected and charging,” “charging complete,” “no device detected,” etc.), a detected class of the device plugged into the USB charging port (e.g., USB 2.0, USB 3.0, USB-C, etc.), or other such status information. The status indicators can comprise any suitable visual or audible output components; e.g., light emitting diodes (LEDs), audible signal generators, electronic text display etc.

As noted above, the charging control component 106 can be configured to execute a negotiation sequence with a USB device plugged into the USB charging port 104 to determine the rated charging current of the USB device and set the maximum charging current to be provided by the power conversion device 102 accordingly. The charging control component 106 can set the maximum charging current based on the detected device class of the USB device, which is indicative of the maximum charging current supported by the device's charging circuitry. For example, some USB devices comprise charging circuitry designed to draw no more than 500 mA of charging current, while other USB devices are designed to draw a maximum of 900 mA. Still other USB devices are capable of supporting even higher current draws to facilitate rapid charging of the device's batteries. For example, devices supporting the USB-C protocol are capable of drawing 2 amps (2000 mA) of charging current at 5 VDC by default, but may have other profiles including 12 VDC at 1500 mA, 12 VDC at 3000 mA, 20 VDC at 5000 mA, or 20 VDC at 3000 mA. These profiles allow such devices to charge their batteries as a faster rate relative to devices that support smaller maximum current draws.

To prevent drawing more charging current then their charging circuits are designed to support, USB devices are typically designed to identify the type of USB charging port into which they are connected, and to request delivery of charging power at a current that does not exceed the charging port's output capabilities (where the request also does not exceed the maximum rated charging current of the USB device itself). A number of different USB charging port types are currently available. For example, a standard downstream port (SDP) that supports USB 2.0 is typically designed to provide charging power at 5 VDC and at a maximum current of 500 mA, while an SDP that supports USB 3.0 is designed to provide charging power at 5 VDC and a maximum current of 900 mA. Charging downstream ports (CDPs) and dedicated charging ports (DCPs) are typically configured to provide a maximum charging current of 1500 mA. If a USB device that supports fast charging at 1500 mA is plugged into a conventional SDP charging port, the device will determine that the charging port is an SDP port based on examination of the voltages on the USB port's data lines, and limit its charging request to 500 mA (the maximum charging current available from the SDP port), even though the device is rated for a much higher charging current.

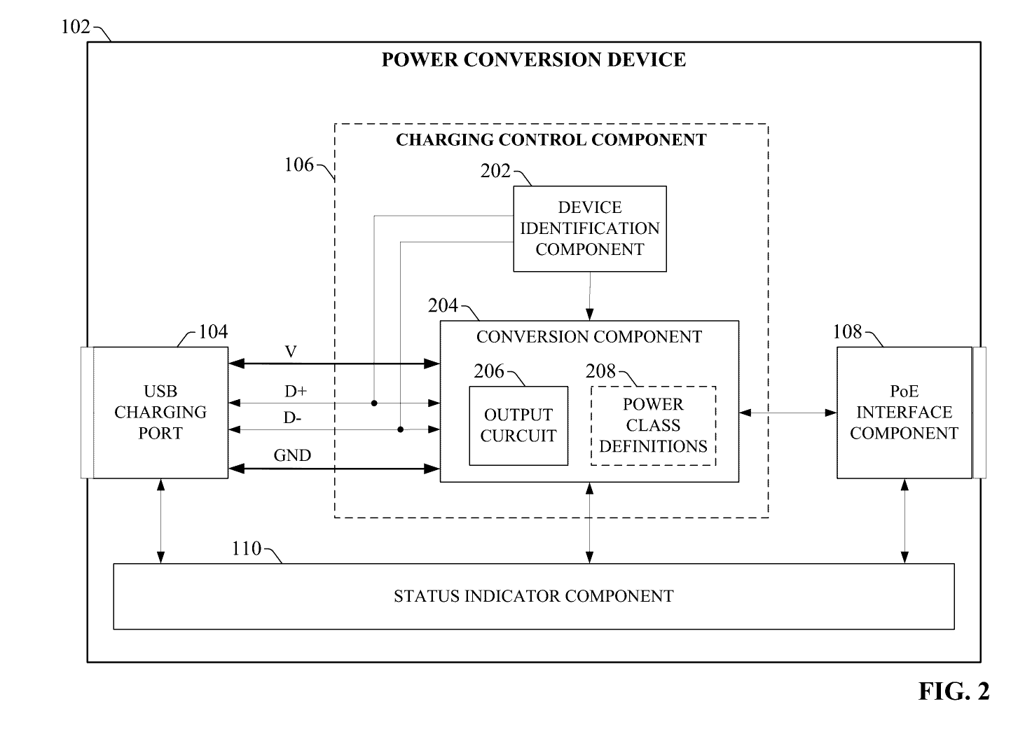

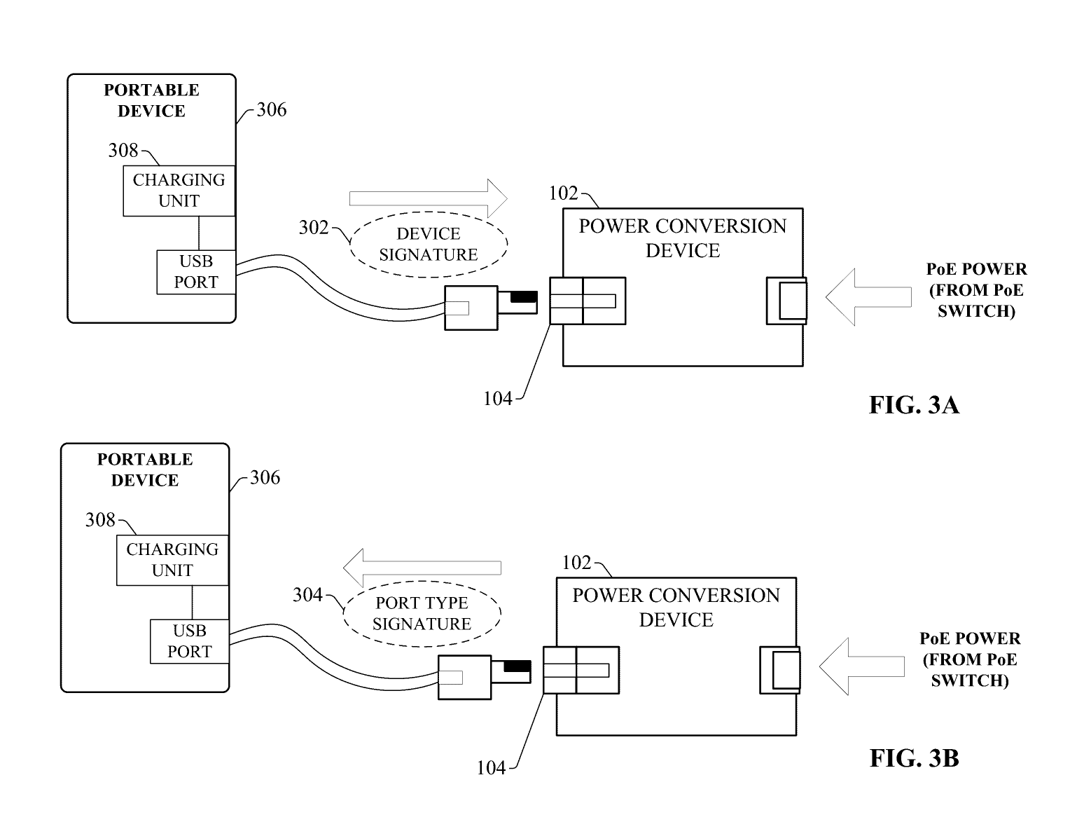

In order to accommodate the charging capabilities of a wide range of USB device types, one or more embodiments of the power conversion device 102 are capable of auto-configuring their maximum charging current output based on a determination of the class of USB device plugged into the USB charging port 104, allowing the power conversion device 102 to act as an SDP, a CDP, a DCP, or other type of charging port depending on the charging capabilities of the USB device being charged. FIG. 2 is a diagram of a power conversion device 102 that includes charging control component 106 capable of setting a maximum charging output based on a determination of the charging capabilities of the USB device being charged. Commensurate with USB standards, the USB charging port 104 comprises four lines—two data lines D+ and D−, a power line V, and a ground line GND. These lines are electrically connected to the corresponding lines of the USB port of a USB device when the USB device is plugged into the USB charging port 104. Turning briefly to FIG. 3A, when a portable USB device 306 is plugged into the USB charging port 104 of power conversion device 102, the charging unit 308 of the USB device 306 places a device signature 302 on the data lines D+ and D−. The device signature 302 can comprise, for example, a distinctive voltage level placed on one or both of the data lines D+ and D−, which is particular to the type of USB charging (e.g., the rated charging current) supported by the USB device 306. In general, the device signature 302 placed on the USB data lines by the USB device's charging unit 308 is indicative of the maximum charging current for which the USB device 306 is rated.

For example, certain USB devices compliant with the Battery Charging Specification Revision 1.2 (BC1.2) charging specification by USB.org may be rated to draw a maximum charging current of 1500 mA. However, such devices will only attempt to draw this maximum charging current if the USB charging port from which the USB device is drawing power is configured to supply charging current at 1500 mA or more. Accordingly, upon being plugged into a USB charging port, the BC1.2-compliant USB device will perform a handshaking sequence with the charging port in order to determine the charging port's type (e.g., SDP, CDP, DCP, etc.). To perform this handshaking, the USB device may place a nominal voltage (e.g., 0.6 VDC) on the D+ line, and read the voltage on the D− line. The voltage level on the D− line in response to the nominal voltage placed on the D+ line indicates to the USB device the type of charging port from which it will be drawing charging power. The USB device may perform additional handshaking steps as needed in order to correctly identify the type of charging port (e.g., by placing a second nominal voltage on the D− line and reading the voltage on the D+ line in order to further narrow the possible charging port types). Once the USB device has identified the type of charging port—which dictates the maximum charging current available from the port—the USB device will request an amount of charging current from the USB charging port that does not exceed the port's maximum available current or the maximum rated charging current of the USB device itself.

The nominal voltages applied to the data lines D+ and D− by the USB device 306 can serve as the device signature 302, from which the power conversion device 102 can ascertain the device class (and associated rated charging current) of the USB device 306. To this end, charging control component 106 includes a device identification component 202 configured to identify a device class of a connected USB device based on examination of the data lines D+ and D−. By examining the voltages on the D+ and D− lines (which serve as a device signature 302), the device identification component 202 can determine the device class (and by extension the rated charging current of the USB device 306), and configure a conversion component 204 to output the converted PoE power at a maximum output current that does not exceed the maximum rated charging current of the USB device.

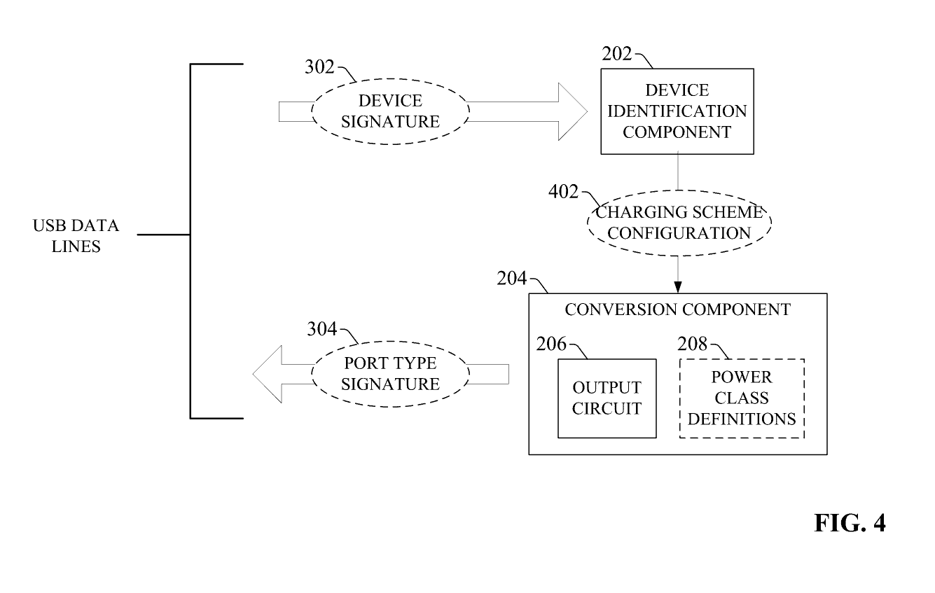

In an example implementation, the conversion component 204 can comprise a configurable output circuit 206 that controls the maximum charging current that will be output by the USB charging port 104 (via the power line V). When a USB device is not plugged into USB charging port 104, the output circuit 206 is set to a default configuration that provides a default maximum charging current (e.g., 500 mA). When a USB device is plugged into the USB charging port 104 (e.g., using a USB cable), the device identification component 202 detects insertion of the device into the port based on the signaling placed on one or both of data lines D+ and D− by the USB device 306. The device identification component 202 also identifies a device class (or charging class) of the USB device 306 based on the signaling placed on D+ and/or D− by the USB device, where the device class is indicative of the maximum charging current for which the USB device 306 is rated. For example, based on the voltage(s) placed on one or both of the D+ or D− lines by the USB device 306 (where the voltage on the D+ and/or D− line serves as the device signature 302), the device identification component 202 may determine that the USB device 306 supports fast charging at 1500 mA. Accordingly, as shown in FIG. 4, the device identification component 202 will apply a charging scheme configuration 402 to the conversion component 204, where the charging scheme configuration 402 instructs the conversion component to configure the output circuit 206 to provide a maximum charging current of 1500 ma (a charging current greater than the default maximum charging current of 500 mA).

In one or more embodiments, the device identification component 202 can determine the correct output circuit configuration to be used for a given device class based on a set of power class definitions 208 stored in a memory associated with the power conversion device. The power class definitions 208 define a set of USB device classes that can be identified based on the device signatures observed on the USB data lines D+ and/or D− when the respective device classes are plugged into the USB charging port 104, as well as the corresponding charging schemes to be used for each defined device class. When the device identification component 202 reads the device signature 302 for a USB device from data lines D+ and/or D−, the device identification component 202 or the conversion component 204 can reference the power class definitions 208 to determine the correct charging scheme to be used for the device class to which the USB device belongs, and configure the output circuit 206 accordingly so that a suitable charging current can be provided to the USB device.

Configurable output circuit 206 can be configured to support a variety of different charging schemes, from which the device identification component 202 can select a suitable scheme for the USB device currently plugged into the USB charging port 104. For example, output circuit 206 can be configured to selectively operate in any of a divider mode (often used by dedicated charging ports); a short mode (e.g., as defined by Chinese Telecommunications Industry Standard YD/T 1591-2009 and USB BC1.2 specifications); 1.2V/1.2V charging mode; or any other suitable charging mode.

As shown in FIGS. 3B and 4, once the output circuit 206 is configured, the conversion component 204 will apply a port type signature 304 to one or both of the D+ or D− data lines to indicate to the USB device 306 a maximum amount of charging current available from the USB charging port 104 (as determined by the output circuit configuration). For example, if the device signature 302 indicates that the portable device 306 is rated for 1500 mA of charging current, the conversion component 204 will set the output circuit to provide a maximum charging current of 1500 mA, and apply an appropriate port type signature 304 to one or both of the USB charging port's data lines indicating to the portable device that the USB charging port is capable of delivering 1500 mA of charging current. The USB device's charging unit 308 will then begin drawing charging current from the USB charging port's voltage lines at a maximum draw defined for the device class to which the device belongs (e.g., 1500 mA).

If the device identification component 202 determines that the USB device 306 is rated for a maximum of 500 mA of charging current, the output circuit 206 will remain in its default configuration and provide a maximum charging current of 500 mA to the USB device, essentially serving as a USB 2.0 SDP for charging purposes. Accordingly, the port type signature 304 applied to D+ and/or D− will convey to the USB device that the USB charging port 104 is a USB 2.0-compliant SDP. If the USB device 306 is determined to belong to a device class rated for 900 mA of charging current, the output circuit 206 will be configured to act as a USB 3.0-compliant SDP (which is capable of providing charging current at 900 mA), and the conversion component 204 will apply a port type signature to D+ and/or D− indicating to the USB device that the USB charging port 104 is a USB 3.0-compliant SDP. Similarly, the output circuit 206 will be configured to act as a DCP capable of providing 1500 mA in response to a determination that the USB device 306 is rated for 1500 mA of charging current, and the port type signature 304 will convey this port type to the USB device. It is to be appreciated that the power conversion device 102 is not limited to these device classes and charging port configurations, and that other device classes and charging port types can be defined by the power class definitions 208 and supported by the charging control component 106.

In one or more embodiments, the port type signature 304 applied to the USB data lines by the conversion component 204 can accord to defined charging scheme standards, to ensure that the USB device plugged into the USB charging port 104 recognizes the configured charging scheme. For example, if the conversion component 204 sets the output circuit 206 to operate in 5 W divider mode (based on a determination by the device identification component 202 that a USB device capable of fast charging with a 5 W adapter has been plugged into the USB charging port 104), the output circuit 206 will apply a 2V signal to the D+ line of the USB charging port 104, and 2.7V to the D− data line in accordance with defined standards for 5 W voltage divider charging. These voltage signals are detected by the USB device, signaling to the device that the USB charging port is a divider DCP capable of delivering 1500 mA. Similarly, for 10 W adapters capable of fast charging, the conversion component 204 will configure the output circuit 206 to operate as a 10 W voltage divider DCP. In accordance with defined divider DCP standards, the output circuit 206 will then apply 2.7V on the D+ line and 2V on the D− line in order to signal to the USB device that the USB charging port is configured as a 10 W voltage divider DCP.

The conversion component 204 can also support a 12 W voltage divider configuration for fast charging USB devices having 12 W adapters. Pursuant to voltage divider DCP charging standards, the output circuit 206 will apply 2.7V on both the D+ and D− lines when configured to operate in this 12 W voltage divider mode. In addition to the voltage divider charging schemes described above, some USB BC1.2 compliant or YD/D 1591-2009 compliant devices support a “short mode” charging scheme whereby the D+ and D− lines are expected to be shorted by an impedance of 200 ohms (or less in some cases). When the device identification component 202 detects that such a device has been plugged into the USB charging port 104, the conversion component 204 can configure the output circuit 206 accordingly, applying the appropriate impedance across the D+ and D− lines in order to signal to the USB device that the USB charging port 104 is configured for a short mode charging scheme. Likewise, when USB devices having charging circuitry that support 1.2V mode are detected on the USB port, the configuration component can configure the output circuit to operate in 1.2V mode, whereby 1.2V is applied to both the D+ and D− lines so that the device can identify the USB charging port 104 as a 1.2V mode port.

Once the output circuit 206 is configured, the configuration will be maintained until the USB device is removed from the USB charging port. In response to a determination by the charging control component 106 that the USB device has been unplugged from the USB charging port 104, the output circuit 206 will return to its default configuration.

In one or more embodiments, the device detection function of the charging control component 106 can be configured with a time-out period that begins when a USB device is detected on the USB charging port 104 (e.g., when a device signature is detected on the USB data lines). If the device identification component 202 is not able to identify the device class of the USB device within the time-out period, the conversion component 204 and its associated output circuit 206 remain in their default configuration, and thus limit the charging current to 500 mA to prevent damage to the USB device due to over-current.

By auto-detecting the charging capabilities of the portable USB devices attached to its USB charging port 104 and configuring the conversion component to provide a level of charging current commensurate with the detected device's rated charging current, a single power conversion device 102 can safely provide converted PoE power to a wide range of portable devices without limiting the ability of those devices to charge at their maximum rates.

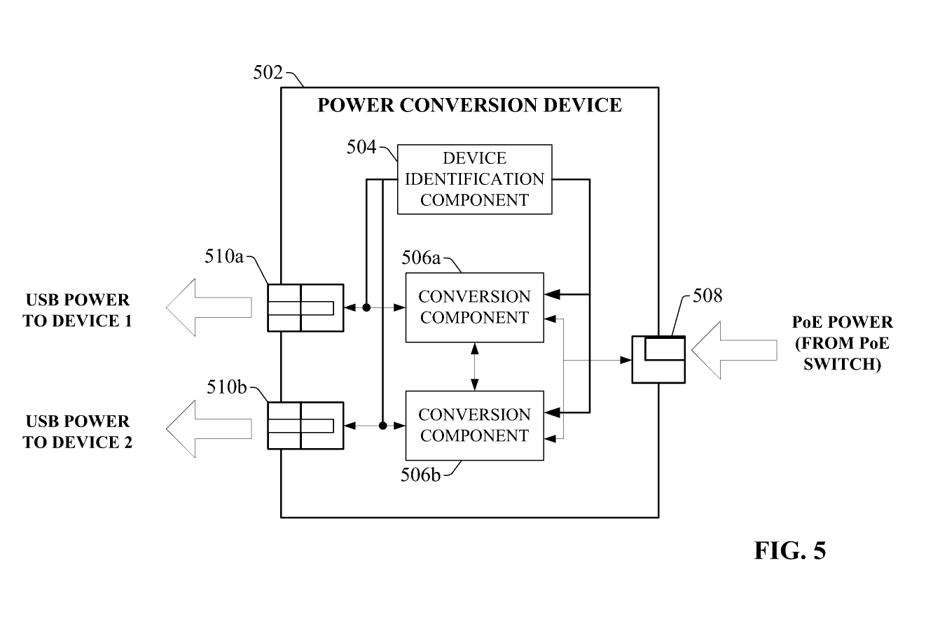

FIG. 5 is a diagram of an example dual-port power conversion device 502. Similar to power conversion device 102, power conversion device 502 comprises a PoE interface component 508 (e.g., an RJ45 plug capable of plugging into an RJ45 jack) that receives PoE power from a PoE switch or other power source. In this example, power conversion device 502 includes two USB charging ports 510a and 510b, and two conversion components 506a and 506b associated with the respective USB charging ports. The conversion components 506a and 506b convert the PoE power to a suitable standard of USB power for delivery to their respective USB charging ports. To this end, device identification component 504 is configured to identify the device signatures placed on the data lines of each of the USB charging ports 510a and 510b, and to configure the conversion components 506a and 506b accordingly, as described in previous examples.

Since the dual-port configuration is capable of charging two devices from the same PoE power source, the negotiation sequence used to configure the output circuits can include an additional verification step to ensure that the total charging current provided to both devices does not exceed the power provided by the PoE power source.

For example, if a total of 10 W of power is available from the PoE power source and the charging current is provided at 5V to each of the two USB devices, the total charging current provided to both devices must not exceed 2000 mA. Accordingly, if a first USB device is plugged into the first USB charging port 510a, the device identification component 504 will first identify the device or charging class of the device based on the device signature, and determine the maximum charging current rated for that device class (e.g., based on the power class definitions). Prior to setting the output circuit associated with the first conversion component 506a to allow this maximum charging current, conversion component 506a will first determine the current configuration and charging status of conversion component 506b to determine the amount of rated current the second USB charging port 510b is configured to provide. If it is determined that setting the first conversion component 506a to provide the full rated charging current will cause the 2000 mA limit to be exceeded, conversion component 506a will instead configure its output circuit to provide the highest level of charging current that will not cause the 2000 mA limit to be exceeded.

In some embodiments, this determination may be based on the amount of charging current the second conversion component 506b is configured to provide, regardless of whether a portable device is currently plugged into the associated second USB charging port 510b. In other embodiments, conversion component 506a will determine a suitable limit on its charging current based on the amount of charging current actually being provided by the second USB charging port 510b to a portable device plugged into that port. In such embodiments, if a second portable device is already plugged into the second USB charging port 510b when a first portable device is plugged into the first USB charging port 510a, the first conversion component 506a may initially be configured to provide a maximum charging current that is less than the rated charging current of the first portable device plugged into the USB charging port if it is determined that outputting the full rated charging current of the first portable device will cause the total available power provided by both charging ports to be exceeded. The conversion component configurations can be dynamically adjusted when devices are plugged into and unplugged from the charging ports. For example, if the second portable device is unplugged from the second USB charging port 510 while the first portable device is still plugged into the first USB charging port, the first conversion component 506a can detect the new availability of additional charging power and reconfigure its output circuit to output the full rated charging current of the first portable device.

Although the example conversion devices are described herein as converting PoE power to USB power for delivery to a portable device via a USB charging port, some embodiments of the modular conversion devices can convert PoE power to charging power deliverable via other types of low voltage ports, including but not limited to audio/video/multimedia ports, digital visual interface (DVI) ports, Ethernet ports, high definition multimedia interface (HDMI) ports, IEEE 1394 ports, separate video (S-Video) ports, video graphics array (VGA) ports, or other such ports.

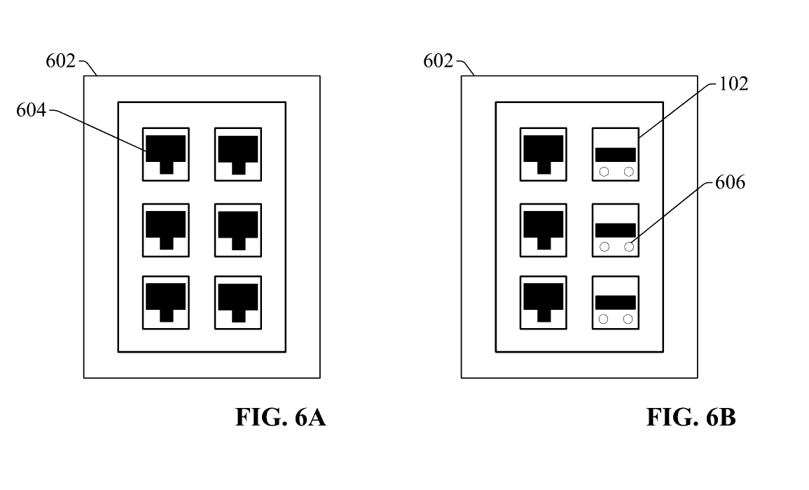

Using the retrofitable power conversion device described herein, existing PoE-enabled Ethernet data ports can be easily repurposed as USB charging ports. FIGS. 6A and 6B illustrate conversion of wall-mounted PoE-enbled Ethernet ports to USB charging ports according to one or more embodiments of this disclosure. As illustrated in FIG. 6A, six Ethernet ports 604 are disposed in a wall plate 602. Ethernet ports 604 are mounted in respective square windows of wall plate 602, and are wired into one or more existing Ethernet networks (not shown). That is, each of the Ethernet ports 604 is connected to an Ethernet cable that runs within or through the wall and connects to a network infrastructure device (e.g., a switch, a router, a hub, a server or other networked device, etc.). Power is provisioned on the one or more Ethernet networks by virtue of a PoE switch, PoE injector, or other such power source, rendering the Ethernet ports 604 PoE-enabled.

According to one or more embodiments, any of the six Ethernet ports 604 can be removed and replaced with a modular power conversion device 102 as described above, thereby converting the PoE-enabled Ethernet port to a USB charging port. FIG. 6B illustrates replacement of the three right-hand Ethernet ports 604 with respective USB power conversion devices 102. In this example, power conversion devices 102 have a mounting footprint compatible with the square windows of wall plate 602, allowing easy replacement of the Ethernet ports 604 with power conversion devices 102. Each power conversion device 102 may include one or more LEDs 606 to indicate status information (e.g., PoE power present, device connected, etc.).

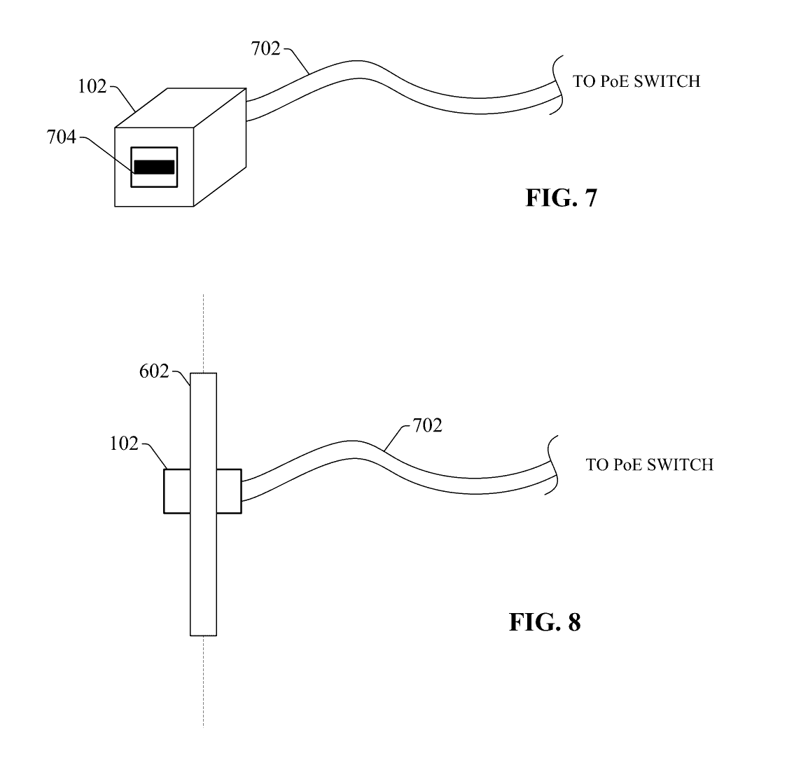

The power conversion devices 102 are connected to the existing PoE-enabled Ethernet network(s) behind the wall plate 602. For example, as depicted in FIG. 7, an existing Ethernet cable 702 that had previously been connected to one of the removed Ethernet ports 604 can be connected to power conversion devices 102, thereby connecting the power conversion device 102 to the existing PoE switch or other PoE power source, as illustrated in FIG. 7. A user can then plug a USB-capable device to the USB port 704 of power conversion device 102 to facilitate charging the device. Various embodiments of power conversion device 102 can support connection to respective different types of Ethernet cable 702 (e.g., CAT-5, CAT-6, or other cable standard that supports Ethernet communication). In some embodiments, power conversion device 102 can include a pre-integrated Ethernet cable 702 for wiring into an existing PoE-enabled Ethernet network or networking device. FIG. 8 is a side view of power conversion device 102 installed in wall plate 602.

Although some examples described herein depict conversion device 102 as being capable of mounting through a wall plate, it is to be appreciated that various embodiments of conversion device 102 can be configured to install in other types of structures, including but not limited to computer equipment racks, table surfaces, seat arm-rests, or other such structures.

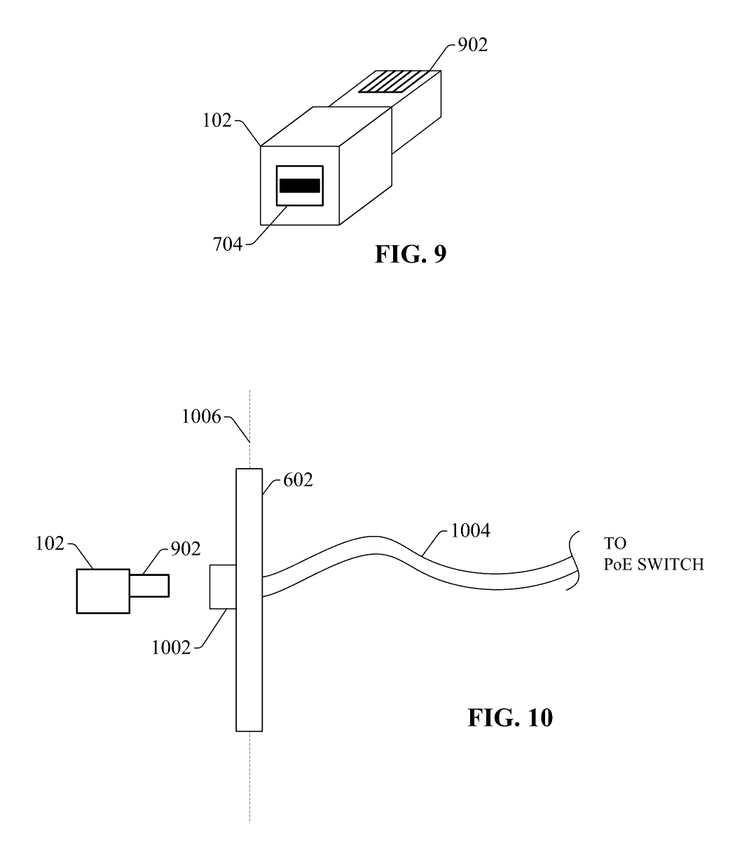

FIGS. 9 and 10 illustrate a portable embodiment of power conversion device 102. This embodiment is configured to plug into an existing PoE-enabled Ethernet port 1002 (e.g., an RJ45 port) without removing the Ethernet port 1002. In this embodiment, power conversion device 102 includes an integrated RJ45 plug 902 that can be inserted into the existing Ethernet port, which is mounted on a wall 1006 and connected to a PoE switch via cable 1004 (e.g., CAT-5, CAT-6, or other type of Ethernet cable). PoE power from the Ethernet port 1002 is provided to PoE interface component 108 disposed within power conversion device 102 (see FIG. 1) via the RJ45 plug 902. This portable embodiment of the power conversion device 102 can be carried by a user and used to quickly convert a PoE-enabled Ethernet data port (e.g., at a public facility such as a library, hospital, airport, school, etc.) to a USB charging port.

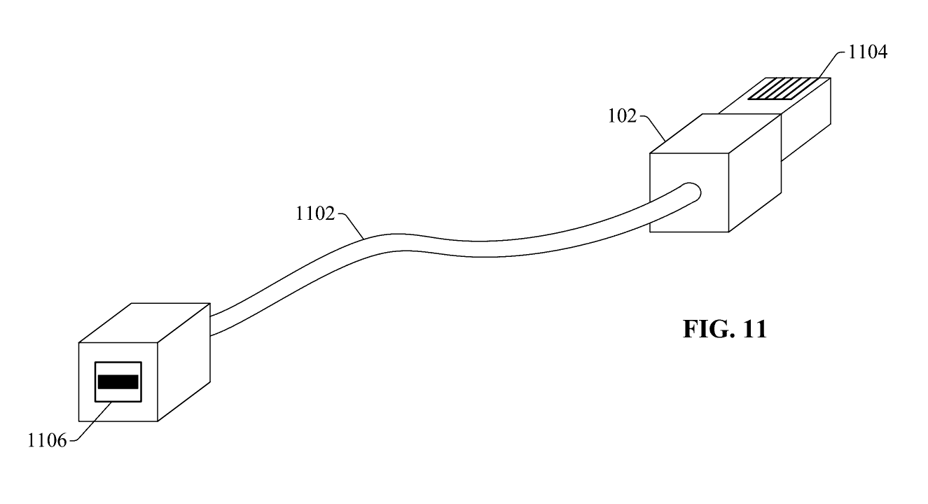

FIG. 11 illustrates another embodiment of power conversion device 102 configured to plug into an existing PoE-enabled Ethernet data port. Similar to the embodiment depicted in FIGS. 9 and 10, the embodiment illustrated in FIG. 11 includes an RJ45 plug 1104 that can be inserted into an existing Ethernet port, and PoE power on the Ethernet port is converted to USB power for delivery to USB port 1106. However, in this example USB port 1106 is attached to power conversion device 102 via USB cable 1102, allowing greater freedom of movement of the USB port 1106 while plugged into the Ethernet port. Although FIG. 11 depicts the power conversion device 102 as being attached to the RJ45 plug 1104, in some embodiments the power conversion components can alternatively be housed with the USB port 1106 on the other end of cable 1102, or inserted in line anywhere along cable 1102.

A variation of the embodiment depicted in FIG. 11 can also be used in connection with the modular embodiments illustrated in FIGS. 6-8. For example, USB port 1106 can be configured to mount inside a square window of wall plate 602, with USB cable 1102, power conversion device 102, and RJ45 plug 1104 residing inside the wall behind the wall plate 602. RJ45 plug 1104 can then be plugged into a port of an existing network infrastructure device (e.g., PoE switch, hub, router, networked device, etc.) to provide PoE power to the power conversion device 102.

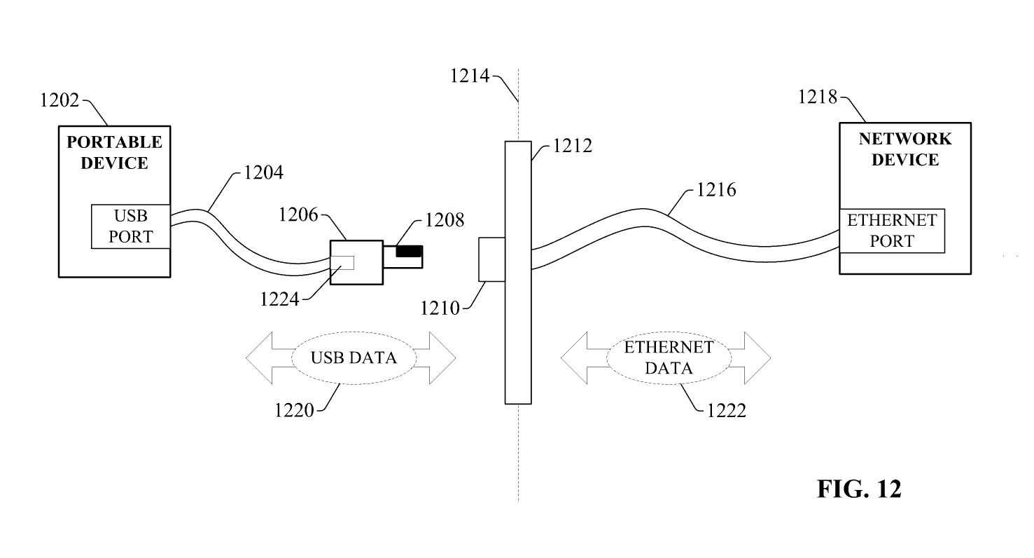

Some embodiments of the PoE-to-USB power conversion device described herein can also be configured to transfer data as well as power. According to such embodiments, in addition to converting PoE power to USB power, the conversion device can also transfer data between the USB port of the conversion device and the PoE-enabled Ethernet network. FIG. 12 illustrates an example configuration that uses a conversion device 1206 to both convert PoE power to USB power and transfer data between a USB device and a PoE-enabled Ethernet network. Conversion device 1206 includes an RJ45 plug 1208 configured to interface with an Ethernet port 1210 in wall plate 1212. Ethernet port 1210 is connected to a network device 1218 (e.g., a server, a router, a hub, a switch, etc.) via Ethernet cable 1216 (e.g., a CAT-5 cable) on the other side of wall 1214. Similar to previous examples, conversion device 1206 converts PoE power on cable 1216 to USB power, which is delivered to a USB port 1224 on the outward face of conversion device 1206. Thus, plugging a portable device 1202 into the USB port 1224 of conversion device 1206 facilitates charging of the portable device 1202 using the converted PoE power. As described in previous examples, conversion device 1206 can determine the rated charging current of portable device 1202 when the device is plugged into the USB port 1224, and set its internal conversion component to provide a level of charging current commensurate with the charging capability of the device 1202 (e.g., by configuring an output circuit that outputs the converted PoE power to the USB port 1224.

In addition, conversion device 1206 can convert USB data 1220 generated by portable device 1202 and sent over USB cable 1204 to Ethernet protocol (e.g., TCP/IP) for transfer over Ethernet cable 1216. Similarly, conversion device 1206 can convert Ethernet data 1222 (e.g., TCP/IP data) generated by network device 1218 to USB protocol for transfer over USB cable 1204. Thus, conversion device 1206 facilitates data transfer between portable device 1202 and network device 1218.

Although FIG. 12 depicts the conversion device 1206 as having a similar form factor as the power conversion device depicted in FIG. 9 (that is, a portable conversion device with an integrated RJ45 plug), it is to be appreciated that conversion device 1206 can also be embodied as a modular wall jack embodiment having a form factor similar to that depicted in FIGS. 6-8. In such embodiments, Ethernet port 1210 can be removed from wall plate 1212, and conversion device 1206 can be installed in the vacant window of wall plate 1212. Ethernet cable 1216 can then be connected to the conversion device to place the conversion device on the network. In this way, conversion device 1206 can be installed as a fixed replacement for Ethernet port 1210.

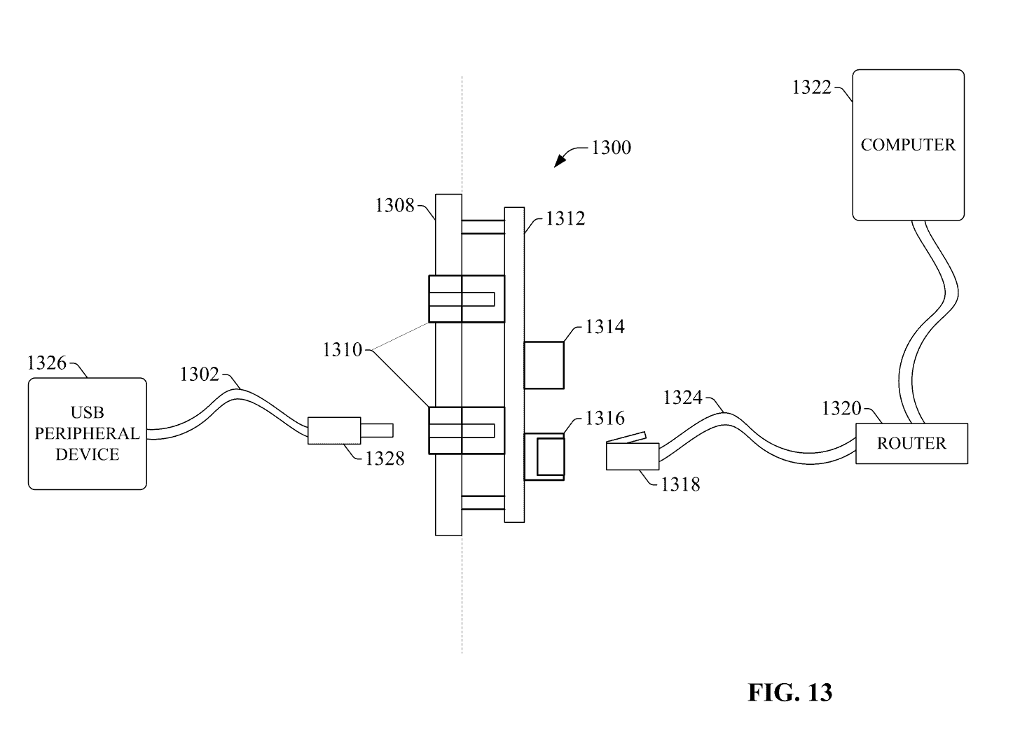

In another embodiment, the USB-to-Ethernet conversion described above can be performed by a fully integrated wall-mountable conversion device. For example, FIG. 13 illustrates a wall-mounted USB-to-TCP/IP conversion device 1300. In this example, a wall plate 1308 includes two USB ports 1310. A USB-to-TCP/IP converter 1314 is mounted to a printed circuit board 1312 attached to the wall plate 1308. Printed circuit board 1312 also has mounted thereto an RJ45 connector 1316. USB-to-TCP/IP converter 1314 is configured to convert TCP/IP data received at the RJ45 connector 1316 to USB formatted data and deliver the USB data to the USB ports 1310. The USB-to-TCP/IP converter 1314 is also configured to convert USB data received at either of the two USB ports 1310 to TCP/IP data (or other Ethernet protocol) and send the data to the RJ45 port 1316.

USB-to-TCP/IP conversion device 1300 can be used to complete a USB connection over an Ethernet network. In a non-limiting example application, a USB peripheral device 1326 (e.g., a speaker, a webcam, a printer, etc.) can be plugged into USB port 1310 using a USB cable 1302 by means of USB connector 1328. A computer 1322 located in another room is connected to an existing Ethernet network via router 1320. An Ethernet plug 1318 terminated to Ethernet cable 1324 of router 1320 can be plugged into RJ45 port 1316 of USB-to-TCP/IP conversion device 1300, thereby networking computer 1322 to the conversion device 1300. Once connected in this manner, USB-to-TCP/IP converter 1314 can facilitate data exchange between USB peripheral device 1326 and computer 1322. That is, USB-to-TCP/IP converter 1314 converts TCP/IP data from computer 1322 to USB-formatted data and sends the data to USB peripheral device 1326 via USB port 1310, and converts USB data from USB peripheral device 1326 to TCP/IP data and sends the converted data to the computer via the Ethernet network. In this way, USB-to-TCP/IP conversion device 1300 allows computer 1322 to communicate with USB peripheral devices (e.g., USB peripheral device 1326) over longer distances than can be achieved using USB alone by leveraging TCP/IP protocol.

In some alternative embodiments, router 1320 can include software and/or hardware configured to convert TCP/IP data received from USB peripheral device 1326 (and converted from an original USB signal) back to USB for delivery to the computer's USB port.

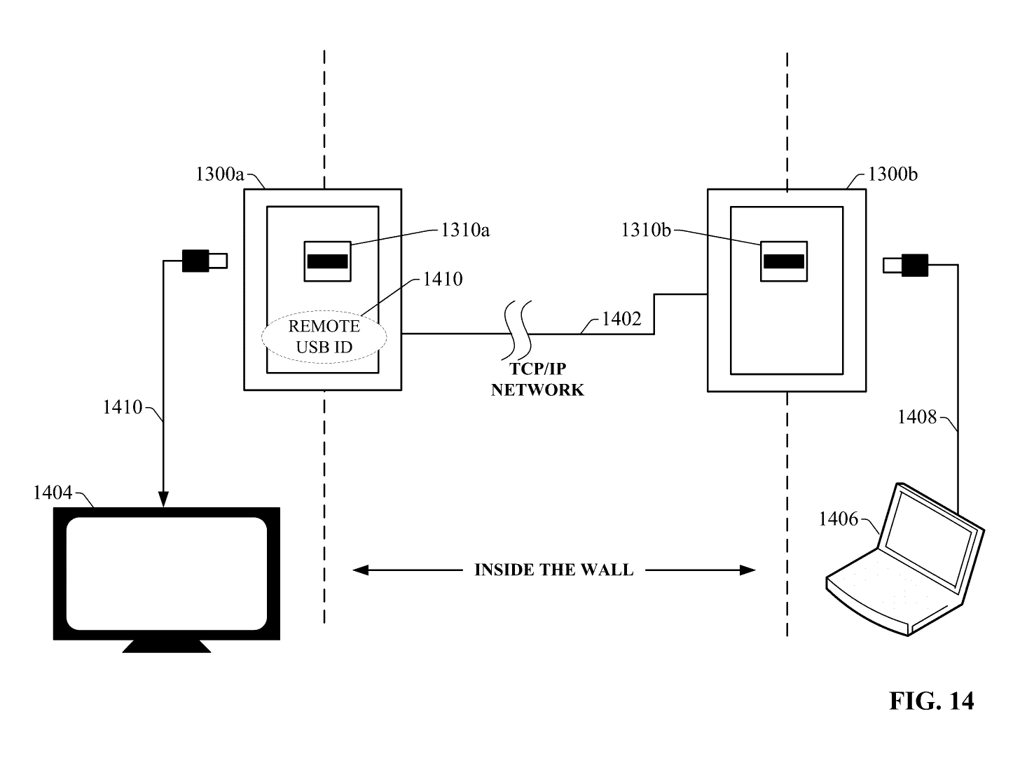

For applications in which computer 1322 is required to exchange data with the USB peripheral device 1326 using a native USB port on the computer, another USB-to-TCP/IP conversion device 1300 can be installed near computer 1322 (e.g., between router 1320 and computer 1322) to facilitate converting Ethernet data received from the USB peripheral device 1326 back to USB at the computer end. FIG. 14 is a diagram illustrating the use of USB-to-TCP/IP conversion devices 1300 to establish a remote USB port. In this example, two USB-to-TCP/IP conversion devices 1300a and 1300b are mounted on walls in different areas (e.g., in different rooms, or on different walls within the same room). The example shown in FIG. 14 depicts each conversion device 1300a and 1300b as being a single-port device (as opposed to the dual-port device of FIG. 13). Similar to the example depicted in FIG. 13, each conversion device 1300a and 1300b includes a USB-to-TCP/IP converter 1314 that converts between TCP/IP data received or sent via an RJ45 connector (or terminals) on the in-wall (rear) side of the conversion devices 1300a and 1300b, and USB data received or sent via the USB ports 1310a and 1310b on the outward-facing side of the conversion devices.

The RJ45 connectors on the in-wall side of the conversion devices are connected to each other within the wall via a TCP/IP network 1402. Network 1402 may be, for example, a single category cable that directly connects the RJ45 connectors together, or may be a multi-branch network that includes one or more network infrastructure devices (e.g., routers, hubs, switches etc.). In this example, the native USB port of a computer 1406 (e.g., a desktop computer, laptop computer, tablet computer, etc.) is connected to the USB port 1310b of conversion device 1300b using a USB cable 1408. On the other end of the connection, a USB peripheral device 1404 (e.g., a USB display, a printer, a headset, speakers, etc.) is connected to the USB port 1310a of conversion device 1300a using another USB cable 1410.

Using this configuration, a USB signal output from the USB port of computer 1406 is received at USB port 1310b, and the conversion device 1300b converts the USB-formatted data to TCP/IP for transfer over network 1402 via the RJ45 connector (or other type of connector) on the back of conversion device 1300b. This TCP/IP data is received at the other conversion device 1300a via the RJ45 connector (or other type of connector) on the back of that conversion device, and the TCP/IP data is converted back to USB data by the conversion device 1300a and output via the USB port 1310a to peripheral device 1404. Similar data conversions can allow data generated by peripheral device 1404 to be sent back to the USB port of computer 1406 via network 1402. In this way, USB port 1310a serves as a remote USB port for computer 1406, allowing USB data to be transferred at longer distances than would be possible by a purely USB communication path.

In order to ensure secure and exclusive point-to-point connectivity between the USB port of computer 1406 and the remote USB port 1310a on conversion device 1300a, one or more embodiments of conversion device 1300a can include a hardware and/or software identifier—referred to as a remote USB ID 1410—that allows computer 1406 to recognize conversion device 1300a as the designated remote USB port corresponding to the local USB port of the computer 1406. In some such embodiments, when conversion device 1300a is connected to computer 1406 via the computer-side conversion device 1300b, the conversion device 1300a provides its remote USB ID 1410 to supporting software executing on computer 1406 via network 1402. In other embodiments, the user may manually enter the remote USB ID for the conversion device 1300a into the supporting software on computer 1406. Once the computer 1406 is provided with the remote USB ID, the conversion device 1300a corresponding to that ID is established as the remote USB port for computer 1406 (that is, the remote USB port corresponding to the local USB port that is plugged into conversion device 1300b). Once this configuration is established, the local USB port on computer 1406 will only accept data originating from the conversion device 1300a (via network 1402), and any USB data that is provided to USB port 1310b by the computer's local USB port will be directed only to the conversion device 1300a by conversion device 1300b.

In addition to the data conversion features described above, some embodiments of the conversion devices 1300a and 1300b can also include PoE-to-USB power conversion features described in previous examples. In this way, if network 1402 is PoE-enabled—e.g. if network 1402 includes a PoE injector, PoE switch, or other type of PoE power supply—the USB ports 1310a and 1310b are also capable of providing USB power by virtue of the PoE-to-USB power conversion functionality. As an alternative to a PoE injector or switch, PoE power may be supplied to the network 1402 by USB peripheral device 1404 (e.g., a phone, a tablet computer, a desktop computer, a laptop computer, etc.) or computer 1406.

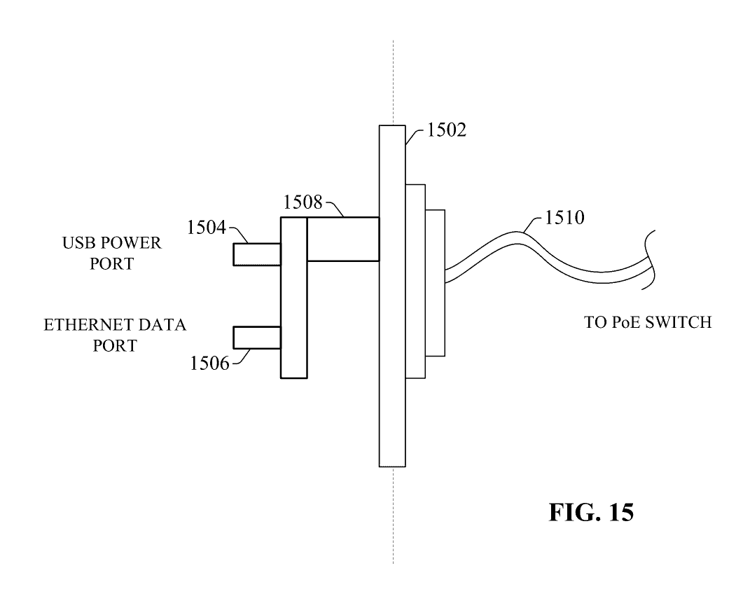

FIG. 15 illustrates a two-port embodiment of the modular conversion device described herein. Similar to previous examples, a conversion device 1508 is configured to convert PoE power from Ethernet cable 1510 (e.g., a CAT-5 cable) to USB power. Conversion device 1508 can conform to any of the modular or portable form factors described above. For example, conversion device 1408 can be equipped with an integrated RJ45 interface (or other Ethernet-compatible interface) that can be plugged into an existing Ethernet data port. Alternatively, conversion device 1508 can be configured to mount in a vacant window of wall plate 1502 as a replacement for an Ethernet data port.

Conversion device 1508 converts the PoE power to USB power, and delivers the converted USB power to USB power port 1404, which thus serves as a USB charging port. Conversion device 1508 can include a device identification component and configurable output circuit that allows the conversion device to negotiate a suitable charging current made available by the conversion device, as described in previous examples. In this embodiment, conversion device 1408 also includes an Ethernet data port 1506 (e.g., an RJ45 port). Conversion device 1508 is configured to pass TCP/IP data between Ethernet cable 1510 and Ethernet data port 1506. Thus, conversion device 1508 facilitates conversion of an existing Ethernet data port to a USB charging port, while maintaining an available Ethernet data port for exchanging TCP/IP data with the Ethernet network.

In some embodiments, USB power port 1504 can also serve as a TCP/IP data port as well as a USB charging port (similar to the embodiment described above in connection with FIGS. 12-14). In such embodiments, conversion device 1508 can format TCP/IP data received via the USB port 1504 for transfer over Ethernet cable 1510, and similarly format TCP/IP data received via Ethernet cable 1510 for transfer via USB power port 1504.

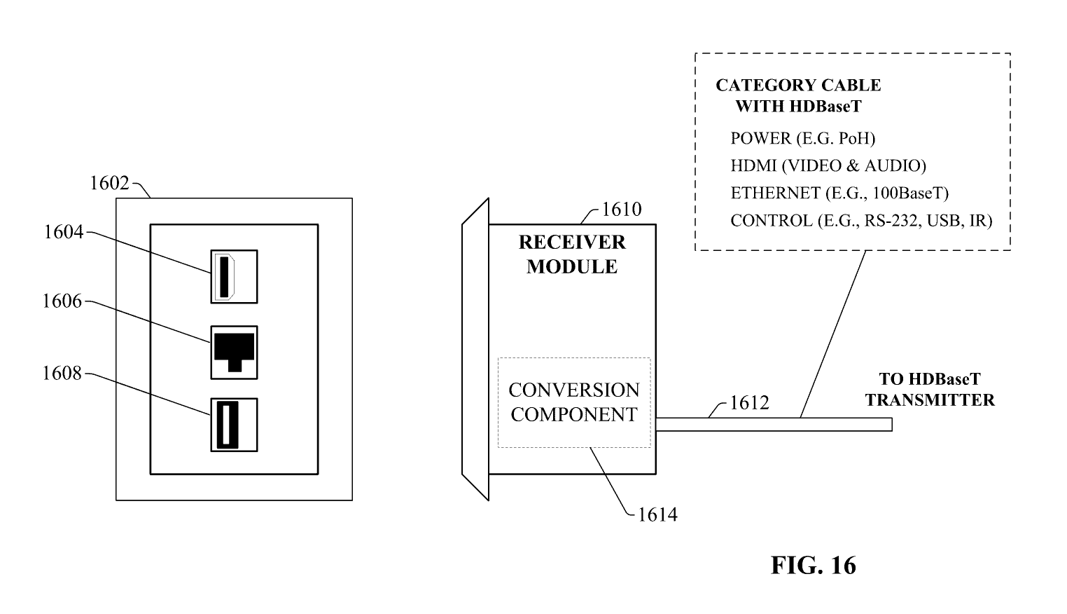

FIG. 16 illustrates a high-definition multimedia interface (HDMI) embodiment for providing power and data connectivity over a category cable using HDBaseT protocol. In this example, an HDBaseT receiver module 1610 is configured to receive a category cable 1612 (e.g., CAT-5, CAT-6, etc.) provisioned with HDBaseT, which supports power (power-over-HDBaseT, or PoH), HDMI video and audio signals, Ethernet, and control signaling (e.g., RS-232, USB, infrared, etc.). In some embodiments, receiver module 1610 can include an RJ45 port that receives category cable 1612, or terminals labeled to indicate which conductors of cable 1612 are to be connected to the respective terminals. Three different ports are located on a wall plate 1602 mounted to the front of receiver module 1610—an HDMI port 1604, an RJ45 data port 1506, and a USB charging port 1608. HDMI port 1604 can conform to any type of HDMI compatible connector type, including but not limited to any of HDMI Types A through E.

In an example configuration, an HDBaseT transmitter (not shown) may be provisioned at the opposite end of the HDBaseT link relative to receiver module 1610. The HDBaseT transmitter serves as the source of HDMI audio and video signals, which are transmitted to receiver module 1610 over category cable 1612 using HDBaseT protocol. In some scenarios, the HDBaseT transmitter includes a power source that provides PoH power to the category cable 1612.

The HDBaseT receiver module 1610 is configured to connect each of the three ports 1604, 1606, and 1608 to the appropriate HDBaseT audio/video, data, or control signals transmitted over the category cable 1612. That is, receiver module 1610 passes HDMI audio and video signals from the category cable 1612 to HDMI port 1604, and passes Ethernet signals between Ethernet port 1606 and the category cable 1612. In addition, receiver module 1610 can include a conversion component 1614 configured to convert PoH power on the category cable 1612 to USB power, and provide the converted USB power to USB charging port 1608. Thus, given a category cable that carries HDBaseT signals between the receiver module 1610 and one or more devices, the receiver module 1610 provides ports for HDMI and Ethernet data communication, as well as a USB charging port 1608 for charging portable devices having a USB interface. As in previous examples, conversion component 1614 can include a device identification component and configurable output circuit that allows the conversion device to negotiate a suitable maximum charging current with the USB device plugged into the USB charging port 1608.

Although HDBaseT receiver module 1610 is described above as having an HDMI port 1604 for outputting HDMI audio and video data received via the category cable 1612, other embodiments of HDBaseT receiver module 1610 can support other audio/video interface standards instead of HDMI, including but not limited to digital visual interface (DVI), Thunderbolt, or DisplayPort.

In some embodiments, USB charging port 1608 can also serve as a USB data port. In such embodiments, receiver module 1610 can facilitate passing of data between USB charging port 1608 and the category cable 1612. The conversion component 1614 can be further configured to convert between USB and TCP/IP data formats, as described above in connection with the embodiment of FIGS. 12-14.

In some embodiments, receiver module 1610, rather than the HDBaseT transmitter at the other end of category cable 1612, can include a power supply that places PoH power to the category cable 1612. Such embodiments of receiver module 1610 can both generate the PoH power for other devices on the HDBaseT network (delivered via category cable 1612) and convert the PoH power to USB charging power for USB port 1608. Alternatively, the power supply of receiver module 1610 may include separate power outputs for the USB charging port (a USB power output) and the HDBaseT link (a PoH power output).

In an example application, embodiments of receiver module 1610 can be used to power a high-definition display device having a relatively low power requirement. For example, an HDMI input cable of a television unit or other display device that utilizes audio and video signal inputs can be plugged into the HDMI port 1604 so that audio/video signals received via category cable 1612 can be delivered to the display device. The display device may also include a USB power input port, which can be connected to USB port 1608 using a suitable USB cable. The converted USB power provided by USB port 1608 thus powers the display device without the need to plug the device into a separate wall outlet.

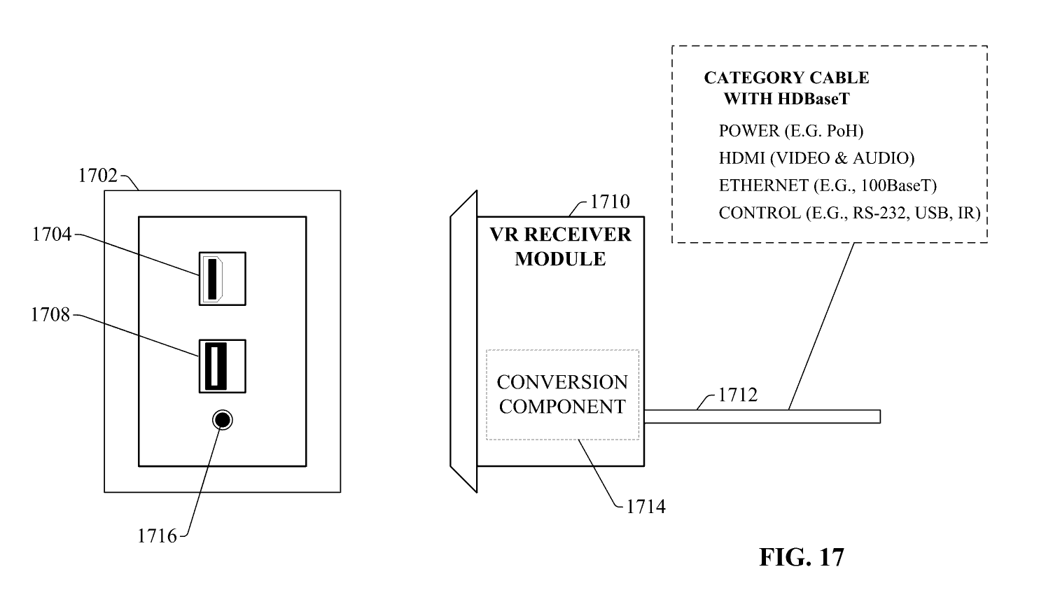

Some features described above can also be embodied in a receiver module that includes HDMI, USB (data), and DC power connections, which allow for convenient connection and extension of devices often used in connection with virtual reality (VR) applications. FIG. 17 is a diagram illustrating a VR receiver module 1710 suitable for use with such virtual reality devices (or other devices requiring HDMI, USB, and power connections). Similar to receiver module 1610, VR receiver module 1710 can be configured to receive a category cable 1712 (e.g., CAT-5, CAT-6, etc.) provisioned with HDBaseT. To this end, the category cable 1712 can include an RJ45 port (or other type of data port) on the rear surface of the module 1710 configured to receive a plug termination on the cable 1712, or may include terminals (e.g., screw terminals, spring terminals, etc.) to which connectors of the category cable 1712 can be attached.

Three ports are located on a wallplate 1702 of module 1710—an HDMI port 1704, a USB port 1708, and a DC power port 1716. These ports are required by many types of virtual reality (VR) devices, such as VR headsets, making module 1710 useful for extending the connection distance of such VR devices relative to the source computer with which these devices communicate. The VR receiver module 1710 is configured to connect the HDMI port 1704 and the USB port 1708 to the appropriate HDBaseT audio/video, data, and/or control signals transmitted over the category cable 1712. That is, similar to receiver module 1610, VR receiver module 1710 passes HDMI audio and video signals from the category cable 1712 to HDMI port 1704, and passes USB data signals between USB port 1708 and the category cable 1712. In addition, VR receiver module 1710 can include a conversion component 1714 configured to convert USB data received at the USB port 1708 to TCP/IP data, and send the converted TCP/IP data over the category cable 1712 via the RJ45 port (or terminals) on the rear (in-wall) side of the module 1710. Conversion component 1714 also converts TCP/IP data received via the category cable 1712 to USB data and outputs this USB data via USB port 1708 on the front of the module 1710. Also, similar to the conversion component of receiver module 1610 described above, some embodiments of conversion component 1714 can be configured to convert PoH power on the category cable 1712 to USB power, and provide the converted USB power to USB port 1708, allowing USB port 1708 to be used as a charging port or as a power supply port for USB-capable devices. Conversion component 1714 can also convert at least a portion of the PoH power to a suitable standard for the DC power port 1716, thereby providing a DC power supply port for a VR client device.

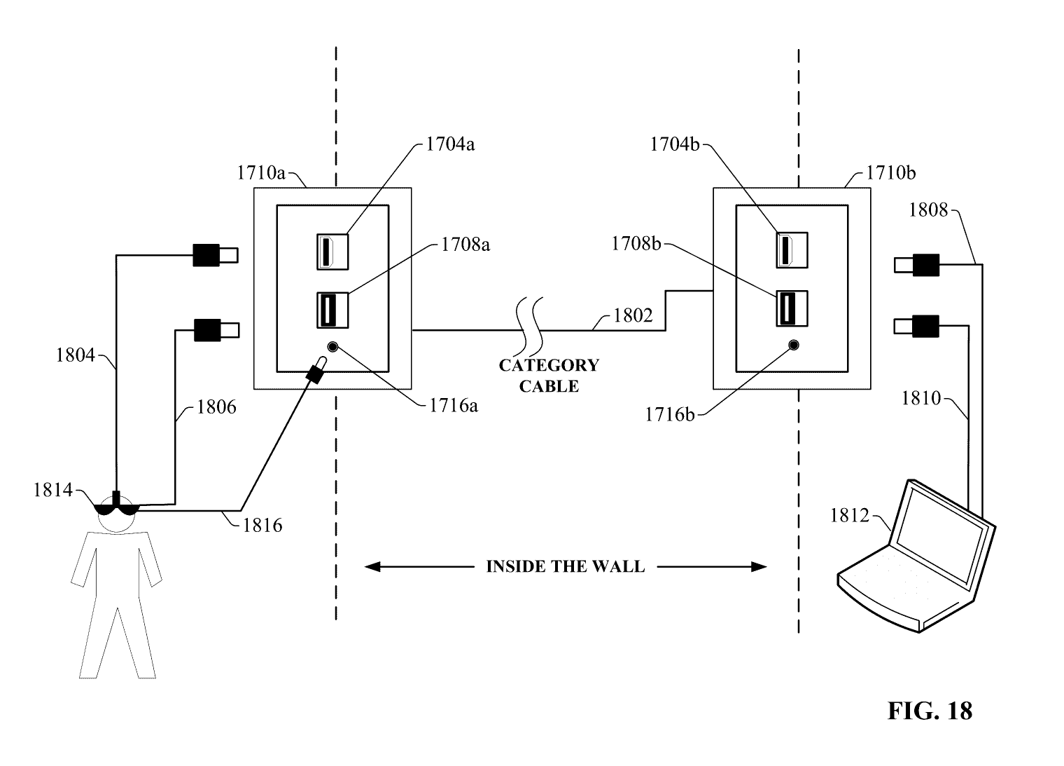

By integrating these features within a wall-mountable module, VR receiver module 1710 can allow a VR client device (e.g., a VR headset or other such device) to be interfaced with a source device—such as a computer that executes a VR game, simulation, or other VR application—from a location that is more distant from the source device than would be possible with a direct connection. FIG. 18 is a diagram illustrating the use of VR receiver modules 1702 to establish a remote connection between a VR client device and a source device. In this example, the source device is a computer 1812 running a VR application, such as a game or a simulation, and VR client device is a VR headset 1814 worn by a user. The VR headset 1814 is designed to interface with the VR application running on computer 1812 to render audio-visual information generated by the VR application in a virtual reality format, as well as to track the user's movement and orientation and to send this tracking information to the VR application on computer 1812. To this end, the VR headset 1814 includes an HDMI cable 1804 and a USB cable 1806 which are designed to interface with corresponding HDMI and USB ports on computer 1812 to facilitate exchange of audio-visual and tracking data between the client device 1814 and the VR application. The VR headset 1814 also requires DC power to operate.

In this example configuration, two VR receiver modules 1710a and 1710b are wall-mounted in two different areas; e.g., in two different rooms, or in different areas of the same room. VR module 1710b is installed near the computer 1812 on which the VR application runs. An HDMI cable 1808 and a USB cable 1810 are used to connect the HDMI and USB ports of computer 1812 to the HDMI port 1704b and USB port 1708b, respectively, of VR module 1710b. A category cable 1802 (or network) that supports HDBaseT is run inside the wall and connects the VR modules 1710a and 1710b together (e.g., by plugging into RJ45 ports or wiring into dedicated terminals on the back of the modules).

An HDMI cable 1804 and a USB cable 1806 are used to connect the VR headset 1814 to the HDMI port 1704a and USB port 1708 of VR receiver module 1710a, thereby establishing a remote connection between the VR headset 1814 and computer 1812 via the category cable 1802. In some embodiments, VR receiver module 1710a may be configured with a remote USB ID (similar to remote USB ID 1410 described above) to ensure that module 1710b recognizes USB port 1708a on the other module 1710a as the dedicated remote USB port for computer 1812. For example, supporting software running on computer 1812 can be configured to read (or be manually provided with) the remote USB ID for the module 1710a, which causes computer 1812 to thereafter recognize USB port 1708a of module 1710a as its remote USB port.

In some embodiments, receiver module 1710 can also include any suitable LED indicators to convey relevant status information for the module, including but not limited to a connection status (e.g., an indication regarding whether communication to another receiver module is established), a communication status, module fault indications, etc.

As noted above, conversion component 1714 of module 1710 can also be configured to convert PoH power on the category cable 1802 (received via the RJ45 port or terminals on the in-wall side of the module) to a DC power standard required for VR client devices and output this converted DC power to DC power port 1716a. Thus, if category cable 1802 is PoH-enabled (e.g., using a PoH injector or switch), the DC power cable 1816 of VR client device 1814 can be plugged into the DC power port 1716a in order to power the device. Some embodiments of conversion component 1714 can also be configured to convert the PoH power to USB power and output this converted USB power via the USB port 1708, thereby allowing USB port 1708 to be used as a USB charging port (or as a source of USB power for other purposes) as well as a data port. As in previously described examples that include such USB charging functionality, some embodiments of the conversion component 1714 can automatically determine a device class of a portable device plugged into the USB port 1708 and configure the USB port to provide the converted USB power at a level suitable for the device class.

Also, in some embodiments, conversion component 1714 can additionally be configured to detect whether a DC power cable plugged into the DC power port 1716 is providing DC power from a power source, and, if so, use this DC power to supply PoH power on a category cable (e.g., cable 1712 or 1802) connected to the RJ45 connector (or terminal) on the rear side of module 1710. In such embodiments, when a plug is inserted into DC power port 1716, conversion component 1714 can identify whether the plug is connected to a power consuming device (e.g., device 1814) or to a power supply device (e.g., a DC power adapter plugged into a wall outlet). In response to determining that the plug is connected to a power supply, conversion component 1714 will perform necessary conversions on the supplied power to facilitate conveyance of power over the category cable (e.g., as PoE power), and inject the power received via the DC power port 1716 onto the category cable, thereby rendering the cable (and its associated network, if applicable) PoH-enabled. In the example depicted in FIG. 18, if the category cable 1802 is not otherwise enabled for PoH, a DC power supply (e.g., a DC wall adapter) can be plugged into the DC power port 1716b of the module 1710b near computer 1812 in order to provide DC power to the VR client device 1814 plugged into the other module 1710. In this configuration, the DC power is first converted to PoH by module 1710b, and is then converted to a DC standard suitable for powering client device 1814 by module 1710a.

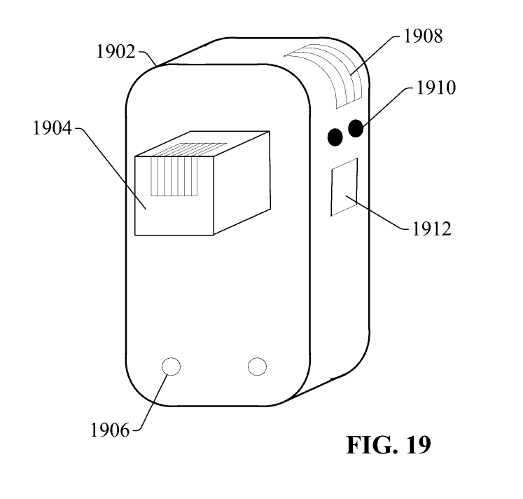

FIG. 19 illustrates a portable, modular device that can leverage PoE power to create a wireless network without the need to plug a wireless router into an external power source. Wireless adapter 1902 includes an Ethernet plug 1904 (e.g., an RJ45 plug) that can be inserted into an available PoE-enabled Ethernet data port. While plugged into an Ethernet data port that carries PoE power, wireless adapter 1902 leverages the available PoE power to power a wireless transceiver 1908 housed in the wireless adapter 1902, allowing wireless devices within range of the wireless transceiver 198 to exchange data wirelessly with the Ethernet data port. Bumpers 1906 made of a soft material can be attached to the wall-facing surface of wireless adapter 1902 to prevent abrasion.

In some embodiments, wireless adapter 1902 can also include a built-in Ethernet data point 1912 that allows hard-wired data exchange between a local device and the wall-mounted Ethernet data port. In this way, wireless adapter 1902 ensures that a physical data port remains available even while the adapter is plugged into the wall-mounted data port.

In various example usage scenarios, the wireless adapter 1902 can be used to easily convert existing legacy Ethernet data ports installed in homes, schools, libraries, coffee shops, or other builds to wireless standards without the need to run a separate power plug to power the wireless transceiver. For example, if a school building has an existing hardwired Ethernet local area network (LAN) installed within the walls of the building and terminated by RJ45 Ethernet ports mounted on walls throughout the building, wireless connectivity to the network can be established by injecting PoE power on the hardwired network (e.g., using a PoE injector or switch), and plugging the wireless adapter 1902 into one or more of the existing wall-mounted RJ45 Ethernet ports. The wireless adapter 1902 leverages the PoE power (received from the RJ45 port via Ethernet plug 1904) to provide power to the wireless transceiver 1908 housed in the wireless adapter 1902, making any necessary power conversions to support the power requirements of the transceiver. Once powered in this manner, the wireless transceiver 1908 serves as a wireless hotspot that allows client devices with wireless capability (e.g., phones, tablet computers, etc.) to wirelessly access the existing Ethernet network

In addition, some embodiments of wireless adapter 1902 can include audio output jacks 1910 for delivering audio signals to speakers or other audio equipment. Audio signals delivered to the audio output jacks 1910 can be driven by an audio source wirelessly connected to wireless adapter 1902 via the wireless transceiver 1908, or from an audio source on the physical Ethernet network.

Although FIG. 19 illustrates wireless adapter 1902 as a module designed to plug into an RJ45 port mounted in a wall, an alternative embodiment of wireless adapter 1902 may be configured as a module designed to mount behind the wall; e.g., as a replacement for a standard wall-mounted Ethernet port. In such embodiments, the wireless adapter 1902 may be mounted behind an RF transparent wall plate that permits transmitting and receiving of wireless signals through the wall plate. The Ethernet data port 1912 and audio output jacks 1910 can be arranged on a front face of the adapter that is flush with the wall in such embodiments.

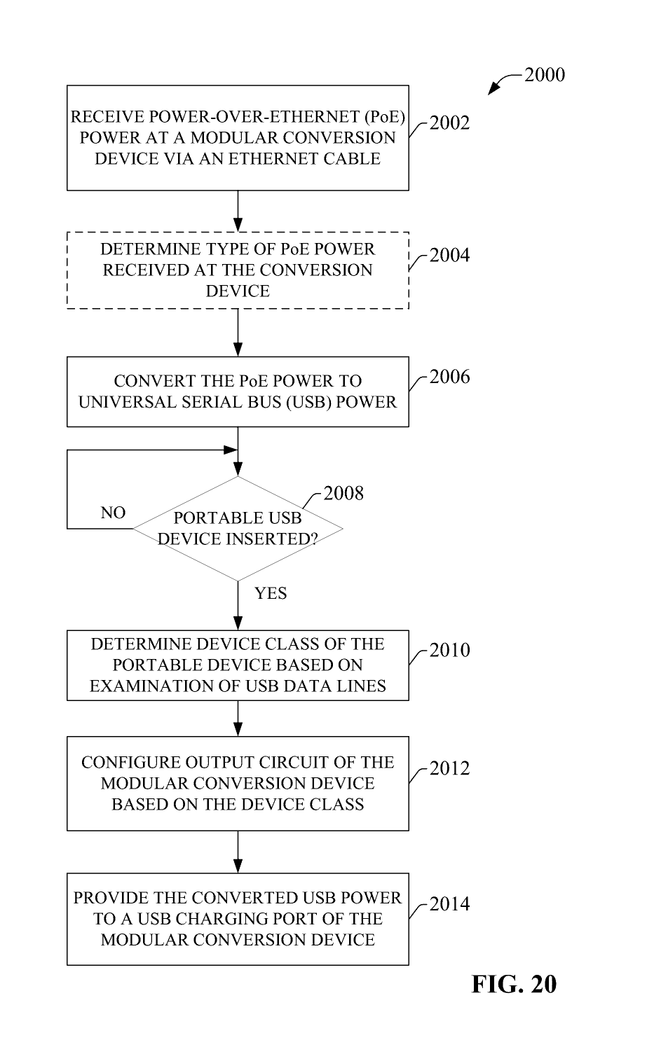

FIG. 20 illustrates a methodology in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 20 illustrates an example methodology 2000 for converting PoE power to USB power. Initially, at 2002, PoE power is received at a modular conversion device via an Ethernet cable. The modular conversion device can be mounted in an available window of a wall plate; e.g., as a replacement for a removable Ethernet data port. In another example embodiment, the conversion device can comprise a portable device (e.g., a dongle) that can be plugged into an existing Ethernet data port (e.g., an RJ45 port).

Optionally, at 2004, the type of PoE power received at the conversion device is determined. For example, the received PoE power may conform to IEEE 802.3af, 802.3at, or another PoE standard. The conversion device may identify the PoE standard based on such factors as the detected voltage level, a determination of which conductors of the Ethernet cable are being used to deliver the PoE power, or other such indicators.

At 2006, the PoE power is converted to USB power by the conversion device. The manner of the conversion may be based in part on the type of the PoE power determined at step 2004. At 2008, a determination is made regarding whether a portable USB device has been inserted into a USB charging port of the modular conversion device. This can be determined, for example, by detection of a characteristic voltage placed on one or both of the USB charging port's data lines by the portable device when the portable device is plugged into the USB charging port.

At 2010, a determination is made regarding a device class of the portable device based on an examination of the voltages or other type of device signature placed on the USB charging port's data lines by the portable device. The device class is indicative of the maximum charging current supported by the portable device. For example, the charging circuitry of a first device may be configured to draw no more than 500 mA of charging current, while a second device that supports faster charging rates may be configured to draw a maximum of 1500 mA or higher.

At 2012, an output circuit that controls the maximum charging current that is output by the modular conversion device is configured based on the device class. This configuration of the output circuit can be performed automatically by the modular conversion device based on identification of the device class to which the portable device belongs. In particular, the output circuit can be configured by the modular conversion device to allow a maximum charging current that matches the determined rated charging current of the portable device (as indicated by the device class).

At 2014, the converted USB power is provided to the portable device via the USB charging port of the modular conversion device, thereby yielding a USB charging port that leverages PoE power. The modular conversion device delivers the converted USB power at a maximum charging current determined by the configuration applied to the output circuit at step 2012.

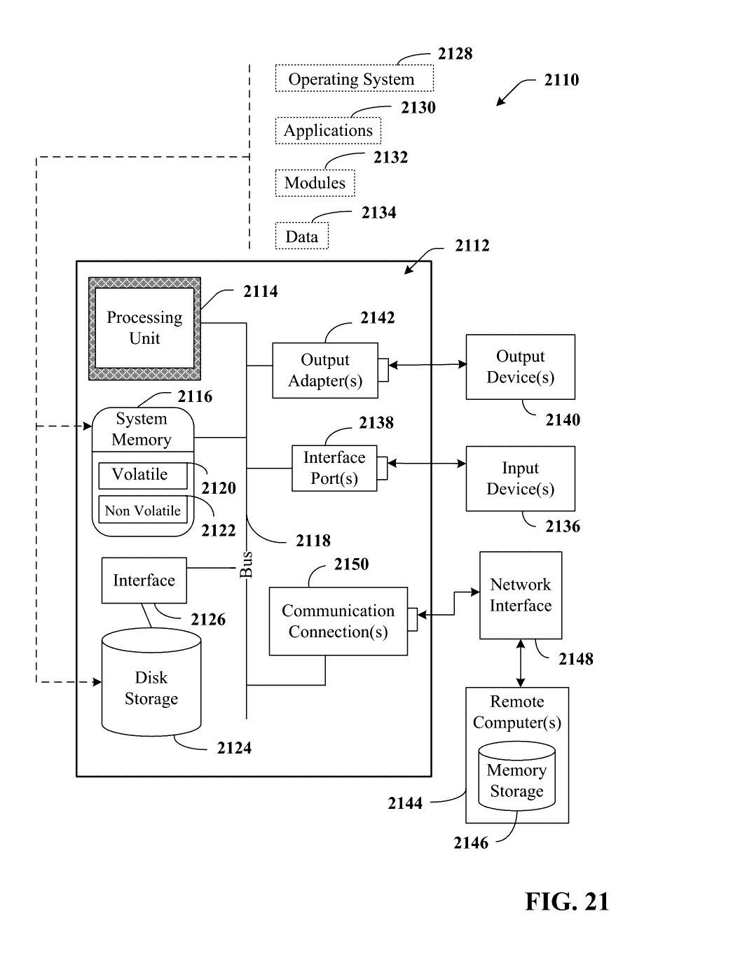

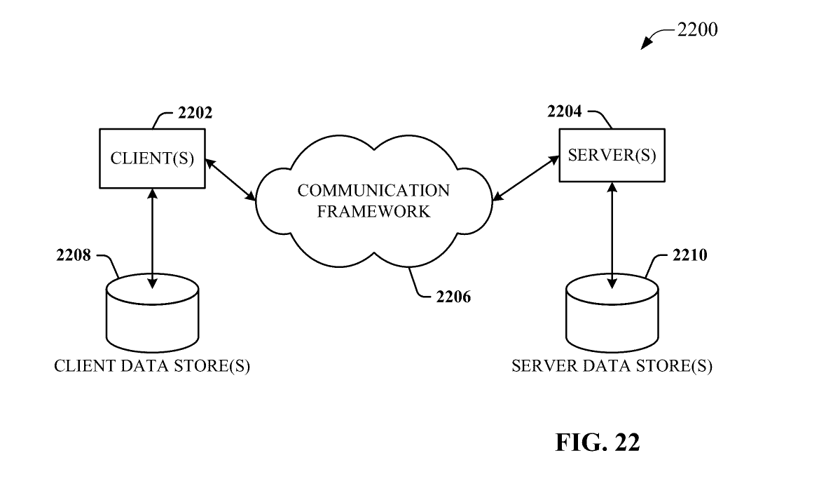

In order to provide a context for the various aspects of the disclosed subject matter, FIGS. 21 and 22 as well as the following discussion are intended to provide a brief, general description of a suitable environment in which the various aspects of the disclosed subject matter may be implemented.

With reference to FIG. 21, an example environment 2110 for implementing various aspects of the aforementioned subject matter includes a computer 2112. The computer 2112 includes a processing unit 2114, a system memory 2116, and a system bus 2118. The system bus 2118 couples system components including, but not limited to, the system memory 2116 to the processing unit 2114. The processing unit 2114 can be any of various available processors. Multi-core microprocessors and other multiprocessor architectures also can be employed as the processing unit 2114.

The system bus 2118 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 2116 includes volatile memory 1820 and nonvolatile memory 2122. The basic input/output system (BIOS), containing the basic routines to transfer information between elements within the computer 2112, such as during start-up, is stored in nonvolatile memory 2122. By way of illustration, and not limitation, nonvolatile memory 2122 can include read only memory (ROM), programmable ROM (PROM), electrically programmable ROM (EPROM), electrically erasable PROM (EEPROM), or flash memory. Volatile memory 1820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 2112 also includes removable/non-removable, volatile/non-volatile computer storage media. FIG. 21 illustrates, for example a disk storage 2124. Disk storage 2124 includes, but is not limited to, devices like a magnetic disk drive, floppy disk drive, tape drive, Jaz drive, Zip drive, LS-100 drive, flash memory card, or memory stick. In addition, disk storage 2124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 2124 to the system bus 2118, a removable or non-removable interface is typically used such as interface 2126.

It is to be appreciated that FIG. 21 describes software that acts as an intermediary between users and the basic computer resources described in suitable operating environment 2110. Such software includes an operating system 2128. Operating system 2128, which can be stored on disk storage 2124, acts to control and allocate resources of the computer 2112. System applications 1830 take advantage of the management of resources by operating system 2128 through program modules 2132 and program data 2134 stored either in system memory 2116 or on disk storage 2124. It is to be appreciated that one or more embodiments of the subject disclosure can be implemented with various operating systems or combinations of operating systems.

A user enters commands or information into the computer 2112 through input device(s) 2136. Input devices 2136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2114 through the system bus 2118 via interface port(s) 2138. Interface port(s) 2138 include, for example, a serial port, a parallel port, a game port, and a universal serial bus (USB). Output device(s) 2140 use some of the same type of ports as input device(s) 2136. Thus, for example, a USB port may be used to provide input to computer 2112, and to output information from computer 2112 to an output device 2140. Output adapters 2142 are provided to illustrate that there are some output devices 2140 like monitors, speakers, and printers, among other output devices 2140, which require special adapters. The output adapters 2142 include, by way of illustration and not limitation, video and sound cards that provide a means of connection between the output device 2140 and the system bus 2118. It should be noted that other devices and/or systems of devices provide both input and output capabilities such as remote computer(s) 2144.

Computer 2112 can operate in a networked environment using logical connections to one or more remote computers, such as remote computer(s) 2144. The remote computer(s) 2144 can be a personal computer, a server, a router, a network PC, a workstation, a microprocessor based appliance, a peer device or other common network node and the like, and typically includes many or all of the elements described relative to computer 2112. For purposes of brevity, only a memory storage device 2146 is illustrated with remote computer(s) 2144. Remote computer(s) 2144 is logically connected to computer 2112 through a network interface 2148 and then physically connected via communication connection 2150. Network interface 2148 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2150 refers to the hardware/software employed to connect the network interface 2148 to the system bus 2118. While communication connection 2150 is shown for illustrative clarity inside computer 2112, it can also be external to computer 2112. The hardware/software necessary for connection to the network interface 2148 includes, for exemplary purposes only, internal and external technologies such as, modems including regular telephone grade modems, cable modems and DSL modems, ISDN adapters, and Ethernet cards.

FIG. 22 is a schematic block diagram of a sample computing environment 2200 with which the disclosed subject matter can interact. The sample computing environment 2200 includes one or more client(s) 2202. The client(s) 2202 can be hardware and/or software (e.g., threads, processes, computing devices). The sample computing environment 2200 also includes one or more server(s) 2204. The server(s) 2204 can also be hardware and/or software (e.g., threads, processes, computing devices). The servers 2204 can house threads to perform transformations by employing one or more embodiments as described herein, for example. One possible communication between a client 2202 and servers 2204 can be in the form of a data packet adapted to be transmitted between two or more computer processes. The sample computing environment 2200 includes a communication framework 2206 that can be employed to facilitate communications between the client(s) 2202 and the server(s) 2204. The client(s) 2202 are operably connected to one or more client data store(s) 2208 that can be employed to store information local to the client(s) 2202. Similarly, the server(s) 2204 are operably connected to one or more server data store(s) 1910 that can be employed to store information local to the servers 2204.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. An apparatus, comprising:
a power-over-Ethernet (PoE) interface component configured to receive power via an Ethernet connection;
a conversion component configured to convert the power to universal serial bus (USB) power and to deliver the USB power to a USB port of the apparatus; and
a device identification component configured to determine a charging class of a portable device plugged into the USB port and to configure a maximum charging current of USB power based on the charging class.

2. The apparatus of claim 1, wherein the device identification component is configured to determine the charging class based on a voltage level measured from at least one of a first data line of the USB port or a second data line of the USB port.

3. The apparatus of claim 1, wherein the conversion component comprises an output circuit that controls the maximum charging current of the USB power, and the device identification component is configured to configure the output circuit based on the charging class.

4. The apparatus of claim 3, wherein the device identification component is configured to configure the output circuit to operate in at least one of a voltage divider mode, a short mode, or a 1.2 volt mode.

5. The apparatus of claim 1, wherein the voltage level is a first voltage level, and the conversion component is configured to place a second voltage level on at least one of the first data line or the second data line indicating the maximum charging current.

6. The apparatus of claim 1, wherein the device identification component is configured to determine the maximum charging current associated with the charging class of the portable device based on a set of power class definitions stored on a memory associated with the apparatus.

7. The apparatus of claim 1, wherein the device identification component is further configured to, in response to a determination that the charging class of the portable device supports a higher charging current than a highest charging current capable of being provided by the power, configure the maximum charging current of the USB power to be the highest charging current capable of being provided by the power.

8. The apparatus of claim 1, wherein the apparatus is configured to mount in a window of a wall plate.

9. The apparatus of claim 1, wherein the PoE interface component comprises a network plug configured to plug into an Ethernet data port.

10. The apparatus of claim 9, wherein conversion component is further configured to:
convert first USB-formatted data received via the USB port to a transmission control protocol/Internet protocol (TCP/IP) format to yield first TCP/IP-formatted data and output the first TCP/IP formatted data via the network plug, and
convert second TCP/IP-formatted data received via the network plug to a USB format to yield second USB-formatted data and output the second USB-formatted data via the USB port.

11. The apparatus of claim 9, wherein the USB port is connected to the network plug via a USB cable.

12. The apparatus of claim 1, wherein the conversion component is further configured to identify a type of the power based on at least one of a detected voltage level of the power or identification of one or more conductors of an Ethernet cable that deliver the power, and to convert the power based on the type of power.

13. A method, comprising:
receiving, by a power conversion device, power-over-Ethernet (PoE) power via an Ethernet port of the conversion device;
converting, by the power conversion device, the PoE power to universal serial bus (USB) power;
determining, by the power conversion device, a charging type supported by a portable device interface with a USB port of the power conversion device; and
setting, by a power conversion device, a charging current limit for the PoE power based on the charging type.

14. The method of claim 13, wherein the determining comprises
measuring a voltage level on at least one of a first data line of the USB port or a second data line of the USB port; and
determining the charging type based on the voltage level.

15. The method of claim 13, wherein the setting comprises configuring an output circuit of the power conversion device.

16. The method of claim 14, wherein the voltage level is a first voltage level, and the method further comprises placing, by the power conversion device, a second voltage level on at least one of the first data line or the second data line indicating the charging current limit available from the USB port.

17. The method of claim 13, wherein the setting comprises
referencing a set of power class definitions that define charging current limits for respective charging types; and
setting the charging current limit based on the referencing.

18. The method of claim 13, further comprising:
identifying a type of the PoE power based on at least one of a measured voltage level of the PoE power or a determination of which conductors of an Ethernet cable deliver the PoE power,
wherein the converting comprises converting the PoE power based on the type of the PoE power.

19. The method of claim 13, further comprising:
converting first USB-formatted data received via the USB port to a transmission control protocol/Internet protocol (TCP/IP) format to yield first TCP/IP-formatted data;
outputting the first TCP/IP formatted data via the Ethernet port;
converting second TCP/IP-formatted data received via the Ethernet port to a USB format to yield second USB-formatted data; and
outputting the second USB-formatted data via the USB port.

20. A receiver module, comprising:
a universal serial bus (USB) port;
a conversion component configured to convert power-over-HDBaseT (PoH) received via a data port of the receiver module to USB power and deliver the USB power to the USB port; and
a device identification component configured to determine a charging class of a device plugged into the USB port and to configure a maximum charging current of USB power based on the charging class.

21. The receiver module of claim 20, further comprising a high-definition multimedia interface (HDMI) port configured to exchange audio and video signaling with the data port.

22. The receiver module of claim 20, wherein
the device identification component is configured to determine the charging class based on a measured voltage on at least one of a first data line of the USB port or a second data line of the USB port, and
the voltage level is a first voltage level, and the conversion component is configured to place a second voltage level on at least one of the first data line or the second data line indicating the maximum charging current.

22. (canceled)

23. The receiver module of claim 19, wherein the conversion component is further configured to:
convert USB-formatted data received via the USB port to a transmission control protocol/Internet protocol (TCP/IP) format to yield TCP/IP-formatted data and output the TCP/IP formatted data via the data port, and
convert TCP/IP-formatted data received via the data port to a USB format to yield USB-formatted data and output the USB-formatted data via the USB port.
